(19) United States
(12) Patent Application Publication
(10) Pub. No.: US 2007/0230577 A1
(43) Pub. Date: Oct. 4, 2007

(54) Apparatus for estimating motion vectors with extended search movement of reference macroblock

(75) Inventor: Takahiro Kobayakawa, Fukuoka (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED, Kawasaki (JP)

(21) Appl. No.: 11/502,537

(22) Filed: Aug. 11, 2006

(30) Foreign Application Priority Data
Mar. 31, 2006 (JP) 2006-096312

(51) Int. Cl. H04N 11/02; H04N 11/04

(52) U.S. Cl. 375/240.16; 375/240.24

(57) ABSTRACT

A motion vector estimation apparatus that can produce motion vectors accurately with an adequately expanded search domain, without increasing computational load too much. A reference macroblock mover moves a reference macroblock in a given reference frame according to a current search pattern, starting from a point identified as a minimum point in a preceding evaluation step. An evaluation processor calculates evaluation values corresponding to specified search movements, thus extracting a minimum evaluation value among as many evaluation values as the number of search movements performed. The evaluation processor finally finds an absolute minimum point from the extracted minimum evaluation values. A search pattern generator provides search patterns specifying extended search movements in a vertical direction so as to move a reference macroblock across different field lines. A motion vector estimator calculates a motion vector representing a distance and direction of the original macroblock relative to the reference macroblock at the absolute minimum point.

### CROSS-REFERENCE TO RELATED APPLICATIONS

This application is based upon, and claims the benefits of priority from, the prior Japanese Patent Application No. 2006-096312, filed Mar. 31, 2006, the entire contents of which are incorporated herein by reference.

### BACKGROUND OF THE INVENTION

1. Field of the Invention

The present invention relates to a motion vector estimation apparatus and more particularly to a motion vector estimation apparatus that estimates motion vectors from interlaced video frames each composed of odd and even fields.

2. Description of the Related Art

Digital video compression techniques are widely used in many industrial and consumer applications such as digital TV broadcast services, DVD movies, video streaming over the Internet, and video recording functions of digital cameras. The available standard specifications for video compression coding include ISO/IEC MPEG standards (e.g., MPEG-1, MPEG-2, MPEG-4) and ITU-T standards (e.g., H.261, H.262, H.264).

Those coding algorithms compress motion information by exploiting high similarity between temporally successive frames in a video stream. A typical video coder divides a frame into macroblocks (MB) with a size of 16×16 pixels and evaluates interframe correlation between frames on a block basis to estimate motion vectors for predictive coding of an original frame with respect to a preceding or succeeding frame. The motion estimator in such a coder performs block matching operations between a given original macroblock and a reference frame, thereby producing evaluation values representing the degree of correlation. The computational load of motion vector estimation is proportional to the area of the search domain. Because it requires large amounts of computation, the motion estimator is often implemented as a dedicated hardware circuit.

A new motion estimation algorithm has been developed in recent years for use in portable video coding devices and software-based video encoders. This algorithm, called “diamond search” (DS), requires a smaller amount of computation. More specifically, the diamond search algorithm evaluates pixel differences between a reference macroblock and an original macroblock while shifting the reference macroblock in several directions within a predetermined search domain. This process produces as many evaluation values as the number of macroblock shifts performed. The algorithm then finds the smallest evaluation value, moves its focus to that minimum point, and performs another cycle of shift-and-evaluate operations at the new point. This is repeated until an absolute minimum of evaluation values is reached, and the reference macroblock at that point is deemed to be the most correlated with the original macroblock.

In the way described above, the diamond search algorithm can estimate motion of macroblocks with a reasonable number of block matching operations and thus is suitable for hardware implementation on a small circuit with low power consumption.

One technique for reducing the amount of computation required for motion vector estimation is disclosed in, for example, Japanese Unexamined Patent Application Publication No. 11-75195 (1999), paragraph Nos. 0024 to 0041 and FIG. 1. According to the technique disclosed in this publication, a primary search seeks candidates for an interframe motion vector for use in a subsequent secondary search to be performed basically with half-pixel resolution. The proposed technique reduces the number of search points in the secondary search by using one-pixel resolution for the candidates with less motion.

Source video signals come either in interlaced format or in non-interlaced (progressive) format. The above-described conventional diamond search algorithm works effectively with non-interlaced (or progressive) signals since adjacent pixels in a non-interlaced reference frame are highly correlated with each other. In the case of interlaced signals, however, two vertically adjacent pixels belong to different fields of a frame. The even-field picture may have significant differences from its corresponding odd-field counterpart, in which case the coder would be unable to find an exact minimum point and thus could make a wrong decision in motion estimation.

A simple way to reduce the chances of erroneous estimation is to expand the search domain. However, doing this expansion blindly to cope with interlaced video sources could spoil the advantage of diamond search, i.e., the suitability for small, low-power circuit solutions.

### SUMMARY OF THE INVENTION

In view of the foregoing, it is an object of the present invention to provide a motion vector estimation apparatus that can produce motion vectors accurately with an adequately expanded search domain, without increasing computational load too much.

To accomplish the above object, the present invention provides a motion vector estimation apparatus that estimates motion vectors from interlaced video frames each composed of odd and even fields. This motion vector estimation apparatus has the following four elements: a reference macroblock mover, an evaluation processor, a search pattern generator, and a motion vector estimator.

The reference macroblock mover moves a reference macroblock in a given reference frame according to search movement parameters contained in a given search pattern of a current evaluation step. The evaluation step starts from a search start point that is identified as a minimum point in a preceding evaluation step. The search pattern generator provides the reference macroblock mover with search patterns each giving a set of search movement parameters for one evaluation step. The search movement parameters include extended search parameters that specify extended search movements of 2n lines (n=1, 2, . . . ) in a vertical direction so as to move the reference macroblock across different field lines.

The evaluation processor calculates an evaluation value, which is either a sum of absolute differences or a square sum of differences between corresponding pixels of the reference macroblock and an original macroblock in a given original frame. This calculation is repeated with a plurality of search movements performed by the reference macroblock mover. The evaluation processor obtains as many evaluation values as the number of search movements performed in the current evaluation step, and thus extracts a minimum evaluation value among those values. In the course of repeating such evaluation steps with a new start point and a new search pattern, the evaluation processor finally reaches an absolute minimum point from the extracted minimum evaluation values. The motion vector estimator identifies the reference macroblock at the absolute minimum point as being most correlated with the original macroblock, and calculates a motion vector representing a distance and direction of the original macroblock relative to the identified reference macroblock.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a motion vector estimation apparatus according to the present invention.

FIG. 2 gives an overview of search movement.

FIG. 3 provides an overview of how a conventional motion estimator works with a basic DS algorithm.

FIG. 4 shows a search pattern of the basic DS algorithm.

FIG. 5A illustrates a five-point search pattern of a 16×16 reference macroblock, and FIG. 5B shows an original macroblock compared with the reference macroblock.

FIG. 6 shows a drawback of the basic DS algorithm.

FIG. 7 shows the structure of a motion vector estimation apparatus.

FIG. 8 shows an example search pattern.

FIGS. 9 to 15 show specific search movements of a pixel block during the course of searching a frame.

FIG. 16 gives an overview of an extended search seen in each pixel.

FIGS. 17 and 18 show macroblock movements in an extended search.

FIGS. 19 to 23 give various examples of search patterns.

FIG. 24 shows a search pattern table.

FIG. 25 is a flowchart of search pattern reading.

FIG. 26 shows prediction directions determined depending on picture types.

FIG. 27 shows search mode and arithmetic unit assignment corresponding to each picture type.

FIG. 28 shows a second variation of the present embodiment.

FIGS. 29 and 30 show a third variation of the present embodiment.

FIG. 31 demonstrates an advantage of the motion vector estimation apparatus according to the present embodiment.

### DESCRIPTION OF THE PREFERRED EMBODIMENTS

Preferred embodiments of the present invention will be described below with reference to the accompanying drawings, wherein like reference numerals refer to like elements throughout.

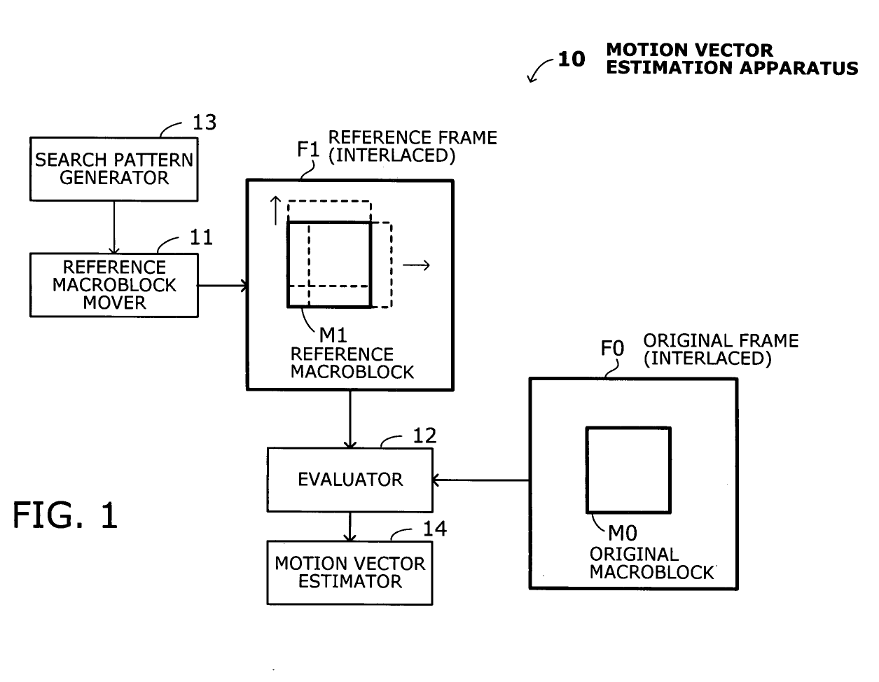

FIG. 1 is a conceptual view of a motion vector estimation apparatus according to the present invention. This motion vector estimation apparatus 10 has the following elements: a reference macroblock mover 11, an evaluation processor 12, a search pattern generator 13, and a motion vector estimator 14. With those elements, the motion vector estimation apparatus 10 estimates motion vectors from given interlaced video frames each composed of odd and even fields.

More specifically, the motion vector estimation apparatus 10 estimates motion vectors from an original frame F0 and a reference frame F1, each of which is formed from an odd field and an even field. The term “original frame” refers to a source frame to be coded, while the term “reference frame” refers to a processed frame temporally preceding the original frame. A temporally succeeding frame may also be used as a reference frame as described in the H.264 standard.

The reference macroblock mover 11 moves a reference macroblock M1 in the reference frame F1 according to a given search pattern, starting from a search start point that is identified as a minimum point in a preceding evaluation step. FIG. 1 illustrates upward and rightward search movements of the reference macroblock M1. Here the term “search movement” of a reference macroblock means moving the search domain to a new position. Or in other words, it means a movement, within a frame, of a search template that is equal in size to a macroblock of 16 pixels by 16 pixels.

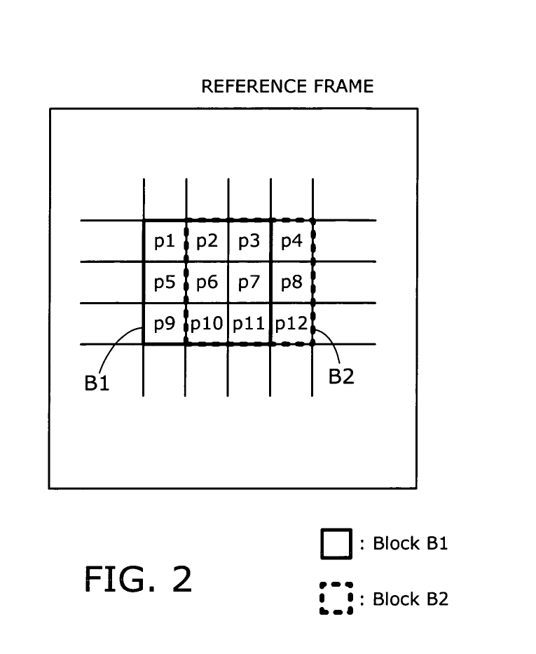

FIG. 2 depicts a search movement, assuming a simplified block consisting of 3×3 pixels for explanatory purposes. Suppose that a 3×3 search template is initially placed at block B1, thus subjecting a set of pixels p1 to p3, p5 to p7, and p9 to p11 to an evaluation process. Then by shifting the search template rightward by one pixel, a new set of pixels p2 to p4, p6 to p8, and p10 to p12 in the neighboring block B2 is subjected to evaluation.

Referring back to FIG. 1, the evaluation processor 12 compares a reference macroblock M1 with an original macroblock M0 in the given original frame F0 by calculating a sum of absolute differences, or alternatively a square sum of differences, between their corresponding pixels. In this evaluation process, the evaluation processor 12 attempts a plurality of search movements specified by a given search pattern, thus producing as many evaluation values as the number of search movements. The evaluation processor 12 then chooses a minimum evaluation value from among the calculated evaluation values.

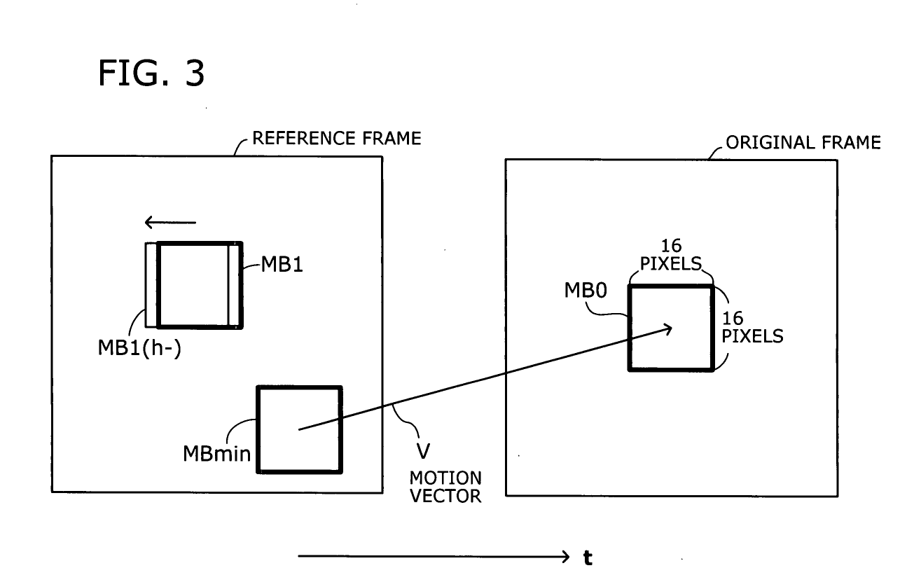

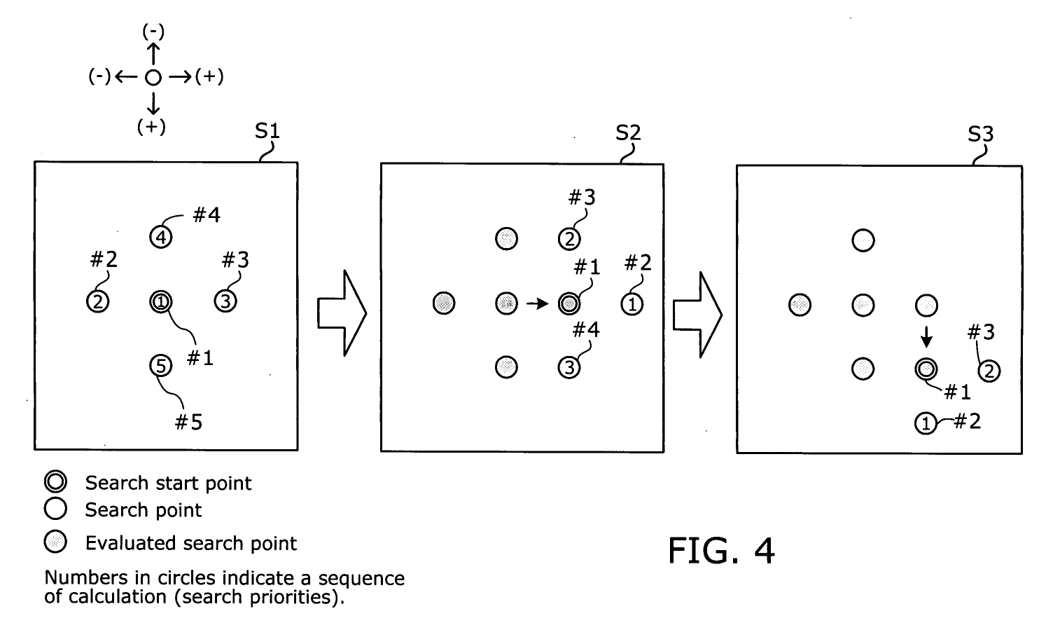

Suppose now that the current search pattern specifies, for example, five displacements for moving the reference macroblock M1. The evaluation processor 12 then calculates five evaluation values corresponding to the five displacements and chooses a minimum value from among the results. This minimum evaluation value indicates that the macroblock at that location has the highest correlation with the given original macroblock M0. During the course of repetitively moving a reference macroblock and seeking a minimum point, the evaluation processor 12 finds an absolute minimum (or global minimum) as will be described later with reference to FIG. 3 and step S3 of FIG. 4.

The search pattern generator 13 provides the reference macroblock mover 11 with search patterns to move the reference macroblock M1. A search pattern gives a set of search movement parameters, including extended search parameters for each evaluation step. The extended search parameters specify extended search movements of 2n lines (n=1, 2, . . . ) in a vertical direction so as to move the reference macroblock M1 across different field lines. This feature of extended search movements enlarges the search domain in vertical directions.

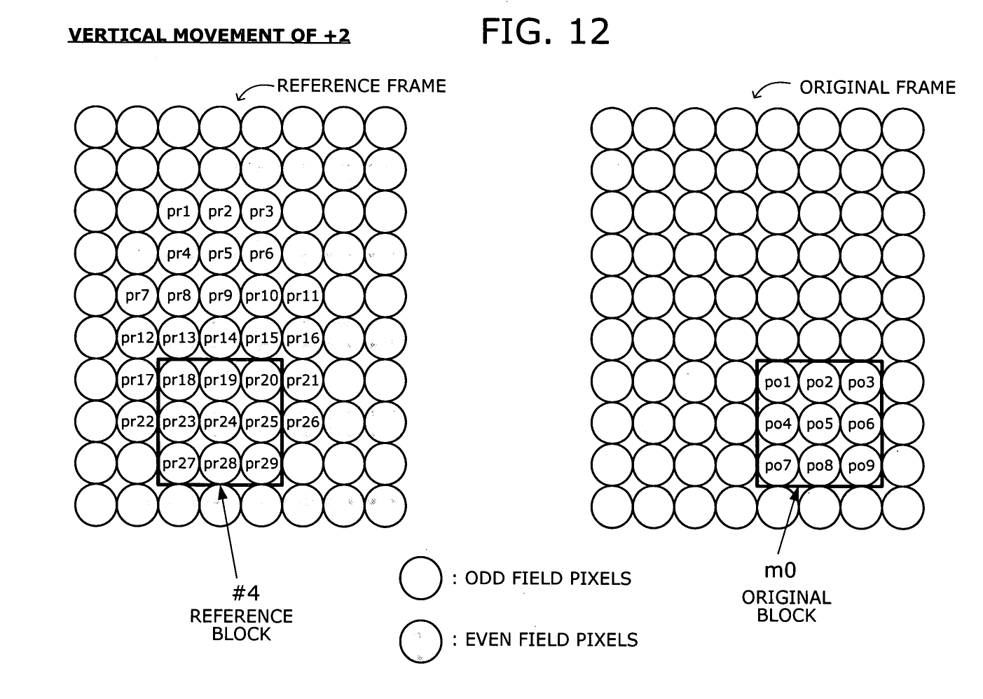

The search pattern generator 13 can be configured with commands and parameters given from some external source. The details of extended search functions will be described later with reference to FIGS. 12 to 18.

The motion vector estimator 14 identifies the reference macroblock at the absolute minimum point as being most correlated with the original macroblock M0. The motion vector estimator 14 then calculates a motion vector representing the distance and direction of the original macroblock M0 relative to the identified reference macroblock.

### Conventional Diamond Search

Before going into details of the present embodiment, this section discusses how the conventional motion estimator works with a diamond search algorithm and what the present invention intends to solve, with reference to FIGS. 3 to 6. Hereafter the conventional diamond search algorithm will often, but not always, be referred to as “basic DS algorithm.”

First, FIG. 3 provides an overview of how the basic DS works. To estimate motion vectors of an original frame on an individual macroblock basis, the motion estimator evaluates difference between a macroblock MB0 in the original frame and a macroblock MB1 in the reference frame by calculating a sum of absolute differences, or alternatively a square sum of differences, between corresponding 16×16 pixels of those macroblocks MB0 and MB1. More specifically, let a_{i,j} be the pixel value of an original macroblock MB0 and b_{i,j} be the pixel value of a reference macroblock MB1, where i=1 to 16 and j=1 to 16. The evaluation function for comparing these two macroblocks MB0 and MB1 is given, for example, as:

$$C = {\sum }_{i , j = 1}^{i , j = 16} \vert {a}_{i , j} - {b}_{i , j} \vert \qquad ( 1 )$$

where the evaluation value C is a sum of absolute differences between pixels at corresponding positions.

After calculating C at the current position, the motion estimator shifts the entire reference macroblock MB1 by one pixel in a horizontal or vertical direction and repeats the same calculation at the new position of the reference macroblock MB1. Think of, for example, a horizontal movement in a negative direction (leftward in FIG. 3) relative to the current position, and let MB1(h−) represent the moved macroblock. The motion estimator then evaluates this new reference macroblock MB1(h−) by using the foregoing formula (1).

The reference macroblock MB1 is moved and evaluated in similar ways, with a displacement of one pixel in each horizontal and vertical direction. This results in five evaluation values that correspond to five points, including the initial central position, of the reference macroblock MB1. The motion estimator then finds the smallest evaluation value among those five values. Using this minimum point as a new central position, the motion estimator performs the same evaluation step while moving the reference macroblock MB1 by one pixel in horizontal and vertical directions.

The above steps are repeated until an absolute minimum is found in the reference frame. The reference macroblock MBmin at that absolute minimum point has the highest correlation with the original macroblock MB0. This implies that the object now seen in the original macroblock MB0 has moved there from where the reference macroblock MBmin is, during the last frame interval (assuming that the reference frame precedes the current original frame by one frame). The amount and direction of this object movement are represented as a motion vector V.

FIG. 4 shows a search pattern of the basic DS algorithm. The circles represent locations of a reference macroblock, and the numbers shown in those circles represent the sequence of search movements. The double circle indicates a search start point, and the hatched circles represent macroblocks that have already been evaluated. The calculation takes place at five points as a search pattern for each evaluation step. The five points include an initial point and four adjacent points with a displacement of one pixel in each horizontal and vertical direction. Note that the original frame and reference frame appearing in the following explanation are non-interlaced frames.

(S1) Search start point #1 is given as an initial point or determined from a result of vector estimation in the past. The motion estimator begins a five-point search at this start point #1, followed by one-pixel movements in each horizontal and vertical direction.

The evaluation step S1 proceeds as follows: (a) evaluate the search start point #1 (i.e., calculate an evaluation value between a reference macroblock at the search start point #1 and a given original macroblock), (b) evaluate the second search point #2 horizontally displaced by −1 with respect to the search start point #1, (c) evaluate the third search point #3 horizontally displaced by +1 with respect to the search start point #1, (d) evaluate the fourth search point vertically displaced by −1 with respect to the search start point #1, and (e) evaluate the fifth search point #5 vertically displaced by +1 with respect to the search start point #1. From among those five search points #1 to #5, the one with a minimum evaluation value is chosen for use as the next start point at step S2.

(S2) Suppose that the third search point #3 has given a minimum evaluation value at step S1. Referring to step S2 of FIG. 4, a new search start point #1 is set to where the minimum evaluation value is found. The motion estimator now begins another five-point search with that new start point #1, but this time it actually skips the first two search points (i.e., point #1 itself and its neighboring point with a horizontal offset of −1) since they have already been evaluated at step S1.

Accordingly, the evaluation step S2 only involves the following three substeps: (a) evaluate the second search point #2 horizontally displaced by +1 with respect to the search start point #1, (b) evaluate the third search point #3 vertically displaced by −1 with respect to the search start point #1, and (c) evaluate the fourth search point #4 vertically displaced by +1 with respect to the search start point #1. From among those three search points, the one with a minimum evaluation value is chosen for use as the next start point at step S3.

(S3) Suppose that the fourth search point #4 has given a minimum evaluation value at step S2. Referring now to step S3 of FIG. 4, a new search start point #1 is set to where the minimum evaluation value is found. The motion estimator begins yet another five-point search with that new start point #1, but this time it only needs to evaluate two search points since the search start point #1 itself and two neighboring points (one with a horizontal displacement of −1 and the other with a vertical displacement of −1) have already been evaluated at step S2.

Accordingly the motion estimator evaluates the second search point #2 with a vertical displacement of +1 and then the third search point #3 with a horizontal displacement of +1.

If the search point #2 or #3 has a smaller evaluation value than the search start point #1, then the motion estimator continues searching after setting a new search start point to there. If neither has a smaller evaluation value than the search start point #1, the motion estimator has no place to move, thus terminating the search. The evaluation value calculated at the search start point #1 in step S3 has turned out to be an absolute minimum, meaning that the macroblock at that point is most correlated with the original macroblock.

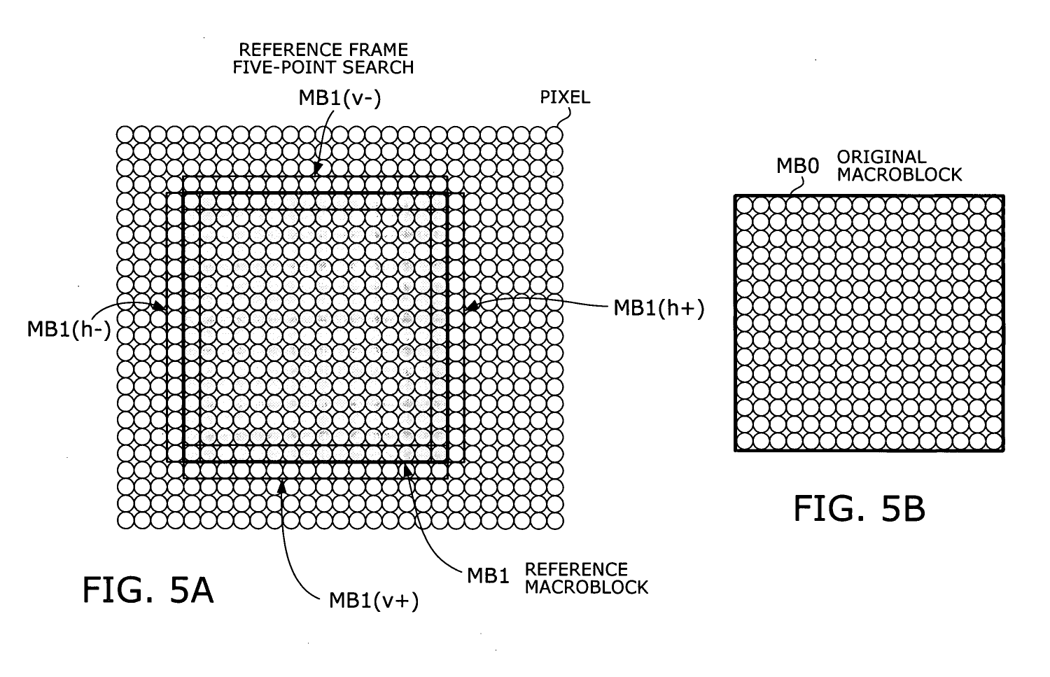

FIGS. 5A and 5B explain how the above five-point search moves a macroblock with a size of 16×16 pixels. First, a given original macroblock MB0 is compared with the reference macroblock MB1 (indicated by a bold square in FIG. 5A) by accumulating pixel differences according to the foregoing evaluation formula (1), thus producing a first evaluation value Ca. Second, the same original macroblock MB0 is compared with a reference macroblock MB1(h−), with a leftward shift of one pixel relative to the reference macroblock MB1, thus producing another evaluation value Cb. Third, the original macroblock MB0 is compared with a reference macroblock MB1(h+), with a rightward shift of one pixel relative to the reference macroblock MB1, thus producing yet another evaluation value Cc. Fourth, the original macroblock MB0 is compared with a reference macroblock MB1(v−), with an upward shift of one pixel (or one line) relative to the reference macroblock MB1, thus producing still another evaluation value Cd. Fifth, the original macroblock MB0 is compared with a reference macroblock MB1(v+), with a downward shift of one pixel (or one line) relative to the reference macroblock MB1, thus producing still another evaluation value Ce.

Out of the five evaluation values Ca to Ce, the motion estimator identifies the smallest one and selects its corresponding reference macroblock as a next search start point. The above operations are repeated until no better reference macroblock is found, and the motion estimator identifies the reference macroblock at the final search start point as being most correlated with the given original macroblock.

### Drawback of Basic DS

The above-described basic DS algorithm can determine optimum motion vectors with a high likelihood by repeating the process described in FIGS. 3 to 5. However, this is only in the case of non-interlaced source videos, where most adjacent lines in a reference frame are highly correlated with each other. This condition does not always hold in the case of interlaced signals since adjacent lines in a frame belong to two separate fields. When the frame contains a large motion, the two field pictures are less correlated, which could lead to an increased chance of wrong determination of minimum points.

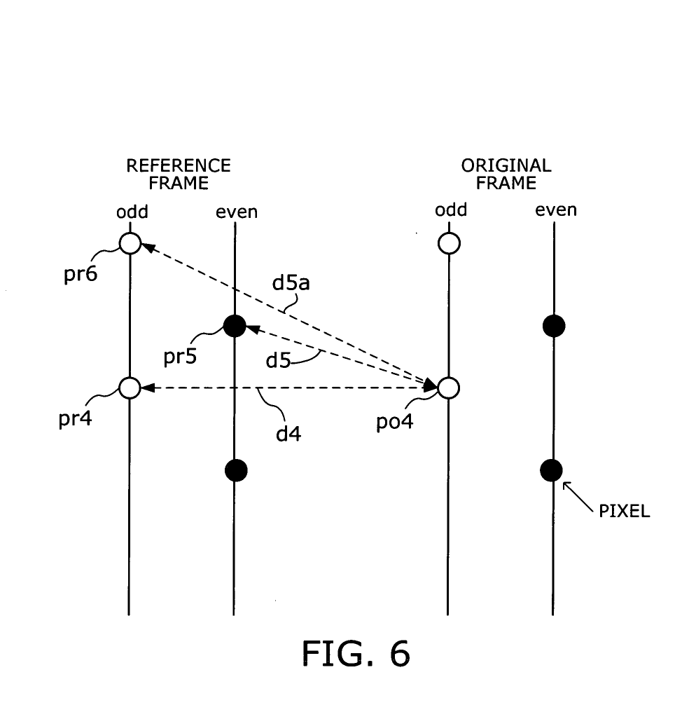

FIG. 6 illustrates a drawback of the basic DS algorithm. One interlaced frame consists of an odd field and an even field. FIG. 6 depicts pixels of each field vertically. Suppose now that the conventioal motion estimator is performing a five-point search pattern according to the basic DS algorithm, with an odd-field pixel pr4 as the fourth search point and an even-field pixel pr5 as the fifth search point in the reference frame. Also suppose that the calculation at the fourth search point has resulted in a difference d4, and that at the fifth search point has resulted in a difference d5. If d5 is smaller than any other evaluation values calculated in the five-point search, the motion estimator finds the pixel pr5 to be the minimum point. (Note: all calculations are actually performed on a macroblock basis, although FIG. 6 gives a pixel-based explanation.)

Some video frames, however, contain a large temporal change between fields while being highly correlated within a field. When dealing with such frames, the motion estimator could encounter a situation where, for example, another odd-field pixel pr6 in the reference frame actually has a smaller difference d5a, or is more correlated with the original frame pixel po4, than the pixel pr5. If that is the case, the true minimum point within the current search pattern should be pr6, rather than pr5. This means that the basic DS algorithm may be confused by interlaced signals, possibly missing an optimal minimum and thus estimating motion vectors incorrectly.

When searching pixels vertically aligned in an interlaced frame, the comparison takes place not only between the same field combinations (i.e., odd reference field and odd original field, or even reference field and even original field), but also between different field combinations (i.e., odd reference field and even original field, or even reference field and odd original field). One way to circumvent the above-described problem in evaluating those same and different field combinations is to enlarge the search domain, or to increase the number of search points per evaluation step. This simple method, however, carries a penalty of increased computational load and power consumption.

There is therefore a need for a new motion vector estimation algorithm that effectively works with interlaced source videos. In this algorithm, the size of search domain are increased in an adequate manner, with optimized search points and search patterns so that the chances of erroneous estimation will be reasonably reduced. The computational load of motion vector calculation should not be increased too much. It has to be also possible to implement the algorithm in a small circuit with low power consumption. The motion vector estimation apparatus according to the present invention fulfills those requirements for more accurate motion estimation, with an adequately expanded calculation domain and a reasonable amount of computation.

### Structure of Motion Vector Estimation Apparatus

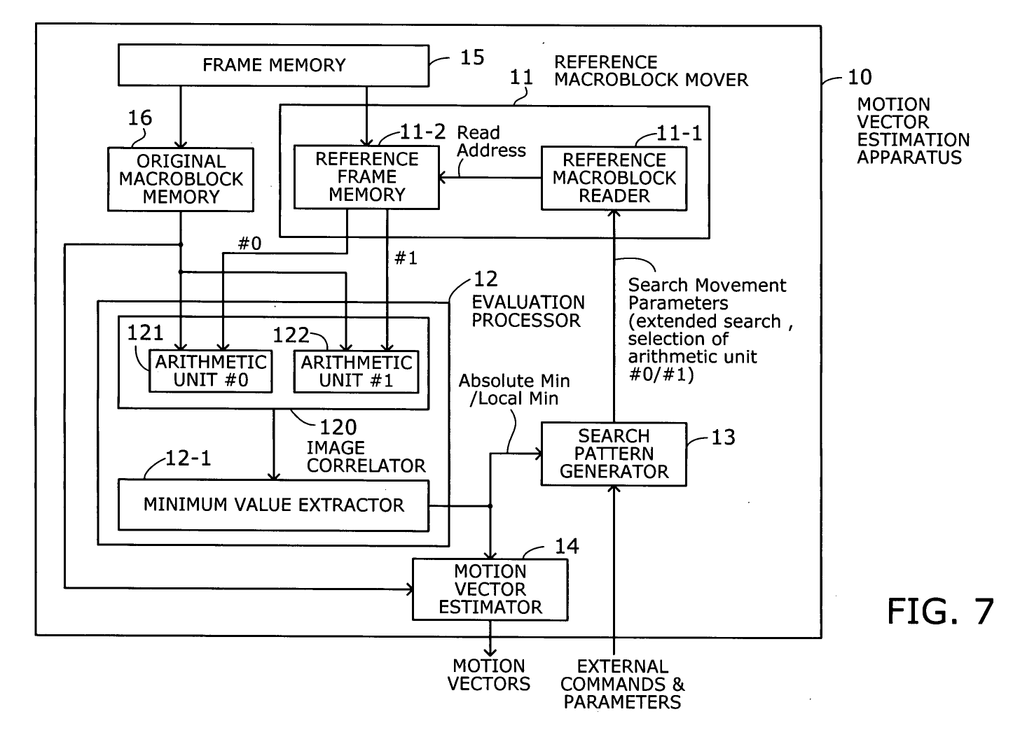

FIG. 7 shows the structure of a motion vector estimation apparatus 10. This motion vector estimation apparatus 10 has the following functional elements: a reference macroblock mover 11, an evaluation processor 12, a search pattern generator 13, a motion vector estimator 14, a frame memory 15, and an original macroblock memory 16. The reference macroblock mover 11 is formed from a reference macroblock reader 11-1 and a reference frame memory 11-2. The evaluation processor 12 is formed from an image correlator 120 and a minimum value extractor 12-1. The image correlator 120 can be implemented with two or more arithmetic units. The present embodiment shown in FIG. 7 employs two arithmetic units 121 and 122, numbered #0 and #1, respectively.

The frame memory 15 stores interlaced source video frames. The original macroblock memory 16 stores an original macroblocks read out of the frame memory 15 for use in motion estimation.

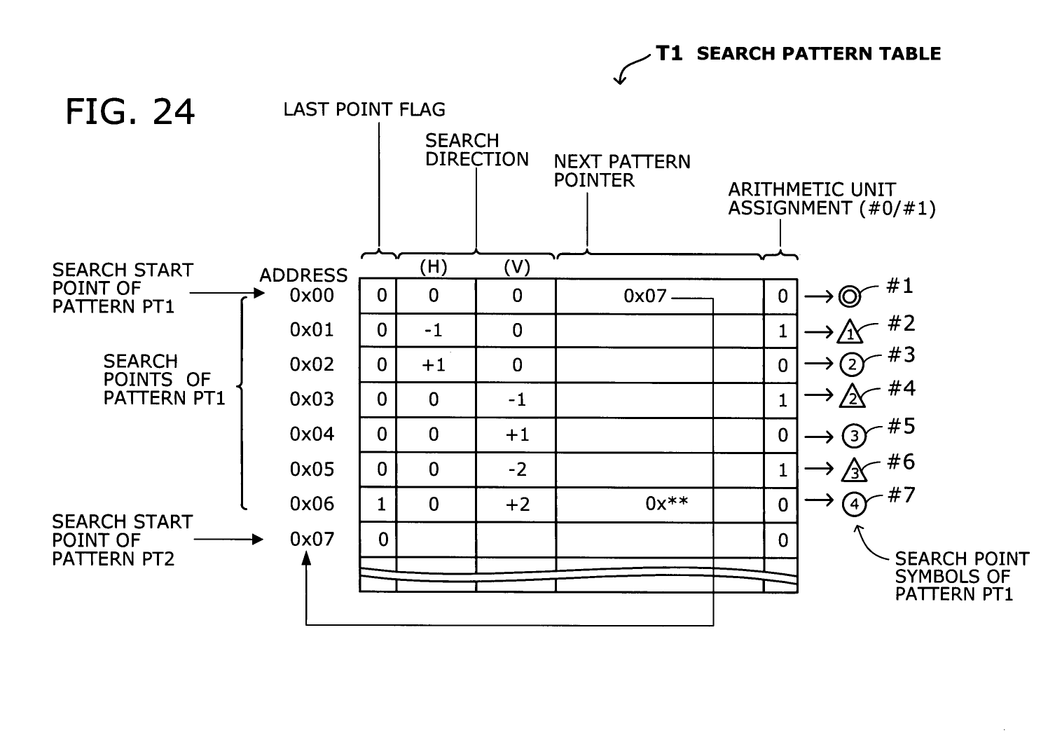

The search pattern generator 13 has a search pattern table (described in detail later in FIG. 24) to provide search movement parameters for use by the reference macroblock mover 11. The search movement parameters include extended search parameters to control extended vertical movements of a reference macroblock across different field lines. Also included in the search movement parameters are instructions as to which arithmetic unit, #0 or #1, to activate. The search pattern generator 13 can be configured with some external commands and parameters specifying an initial search point and other table contents.

The reference macroblock reader 11-1 calculates read address of a reference macroblock from given search movement parameters and reads out that reference macroblock from the reference frame memory 11-2. The data of this reference macroblock is directed to the arithmetic unit #0 121 or arithmetic unit #1 122, depending on which unit is selected for calculation. The two arithmetic units 121 and 122 in the image correlator 120 are designed to run in parallel to execute assigned calculation tasks. The resulting evaluation values are supplied to the minimum value extractor 12-1, which finds a minimum value locally in each evaluation step and determines finally an absolute minimum value from among those local minimum values.

The minimum value extractor 12-1 notifies the motion vector estimator 14 of the absolute minimum value and its corresponding reference macroblock. The reference macroblock at that absolute minimum point is deemed to be most correlated with the original macroblock. The motion vector estimator 14 then calculates a motion vector representing the distance and direction of the absolute-minimum reference macroblock.

### Search Pattern PT1

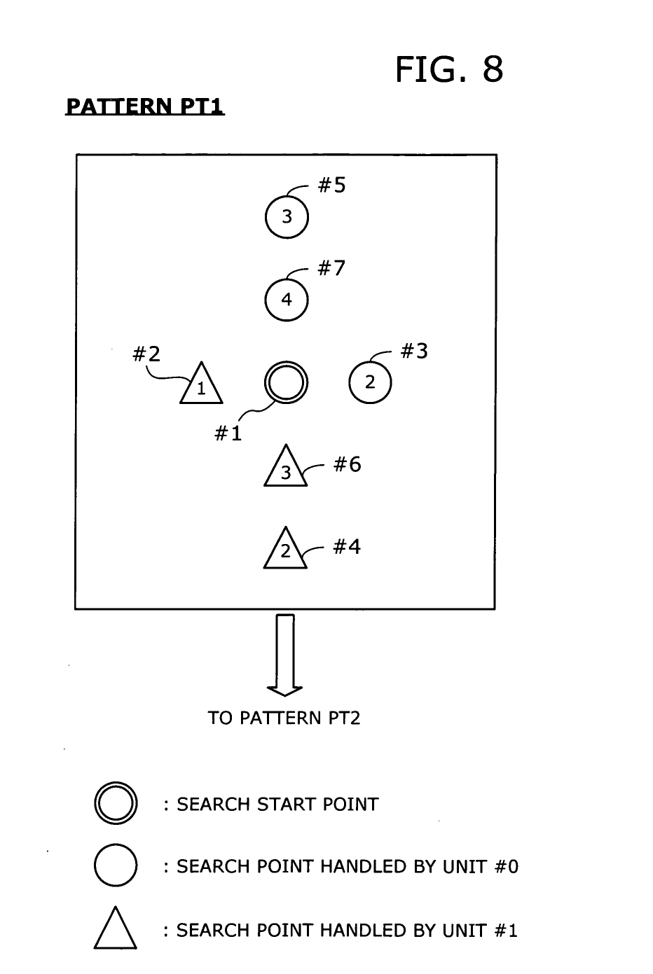

This and subsequent sections will describe specific search operations. FIG. 8 shows an example search pattern PT1 that the motion vector estimation apparatus 10 uses. The circles and triangles shown in FIG. 8 represent searched macroblocks (or reference macroblocks) in a reference frame. The numbers in those circles indicate the sequence of search movements. The double circle represents a reference macroblock at the search start point. The single and double circles are reference macroblocks assigned to the arithmetic unit #0 121, while the triangles are reference macroblocks assigned to the arithmetic unit #1 122.

Pattern PT1 is used at the very beginning of a motion estimation process. Subsequent search movements take place in both horizontal and vertical directions around the search start point #1. Specifically, the pattern PT1 includes horizontal displacements of ±1 and vertical displacements of ±1 and ±2, all with respect to the search start point #1. The search domain is extended in a vertical direction, thus permitting the reference macroblock to move across both even and odd field lines.

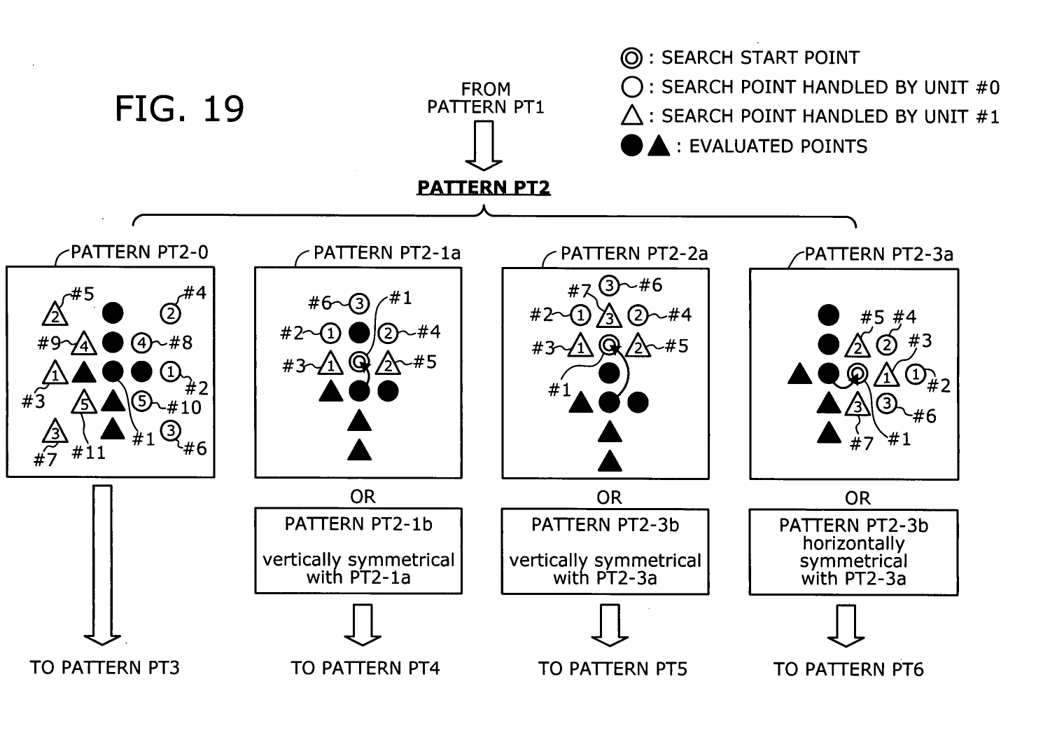

More specifically, the evaluation step begins with evaluation of the first two search points #1 and #2. As described earlier, the term “evaluation” refers to calculating the difference between a reference macroblock at a specific search point and a given original macroblock. The two search points #1 and #2 can be evaluated in a parallel fashion by the arithmetic unit #0 121 (hereafter, “unit #0”) and arithmetic unit #1 122 (hereafter, “unit #1”). This is followed by another parallel evaluation of the third and fourth search points #3 and #4 by the units #0 and #1, respectively. Likewise, the two units #0 and #1 evaluate the fifth and sixth search points #5 and #6 simultaneously. The current evaluation step ends with the seventh search point #7 evaluated by unit #0. The next search start point is then selected as a local minimum point among those seven search points, and the estimation process advances to another evaluation step with another search pattern. Depending on which of the seven search points #1 to #7 is found minimum, a different search pattern will be used in the subsequent evaluation step, as will be described later with reference to FIGS. 19 to 23.

### Search Movements

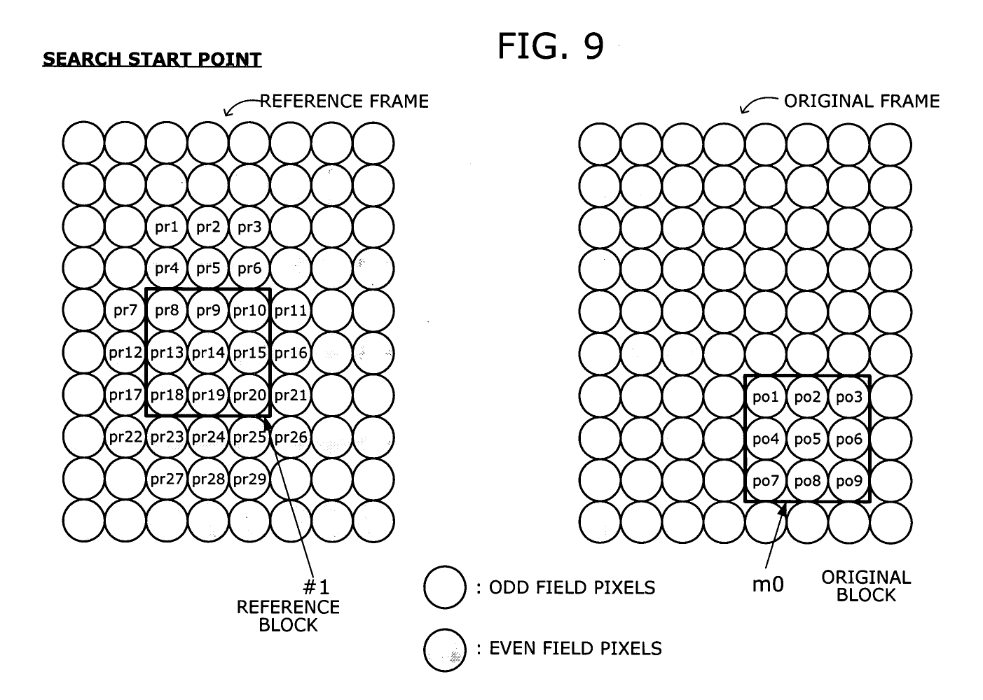

Before explaining other search patterns that follow the initial pattern PT1, this section will give specific search movements of a pixel block during the course of searching a frame. FIGS. 9 to 15 show detailed search movements contained in PT1, where the hatched circles represent even-field pixels and the non-hatched circles represent odd-field pixels. It is assumed, for explanatory purposes, that one block consists of 3×3 pixels. There will be no mention of arithmetic units #0 and #1, since it does not matter which arithmetic unit is assigned.

FIG. 9 shows a reference block #1 located at the search start point #1 in a reference frame. An original block m0 containing pixels po1 to po9 is located in an original frame as shown in the right half of FIG. 9. The reference block #1 is formed from pixels pr8 to pr10, pr13 to pr15, and pr18 to pr20. The evaluation processor 12 in this case calculates absolute differences between corresponding pixels as follows: |pr8−po1|, |pr9−po2|, |pr10−po3|, |pr13−po4, . . . |pr20−po9|. The evaluation processor 12 then sums up those values, thus obtaining a first evaluation value C1.

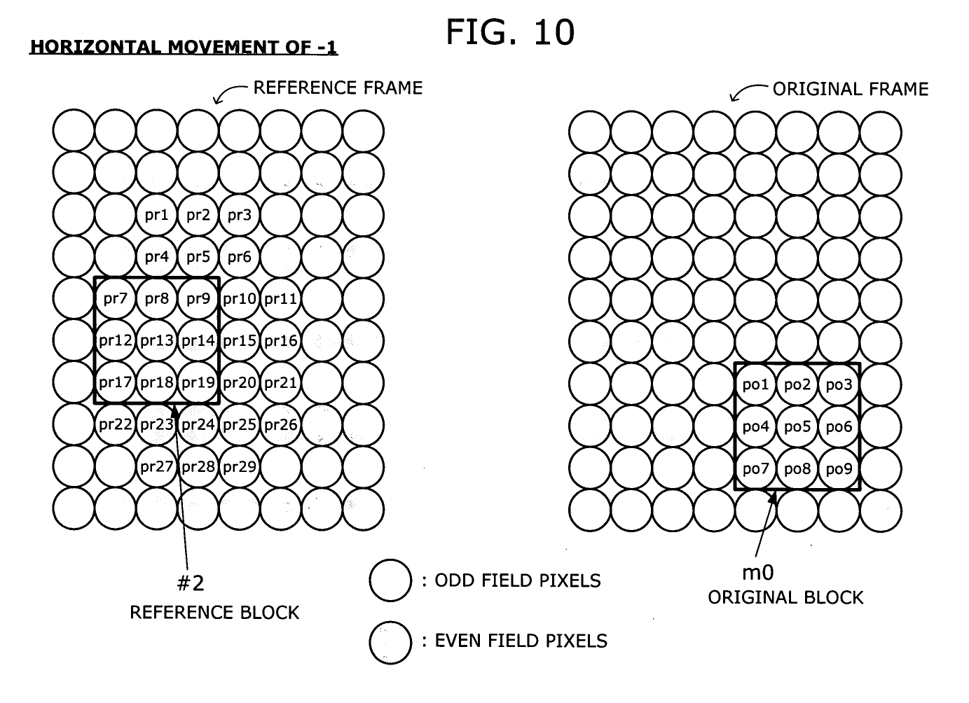

FIG. 10 shows a reference block #2 at the second search point #2, horizontally displaced by −1 pixel with respect to the search start point #1. This reference block #2 contains pixels pr7 to pr9, pr12 to pr14, and pr17 to pr19. The evaluation processor 12 sums up absolute pixel differences |pr7−po1|, |pr8−po2|, |pr9−po3|, |pr12−po4|, . . . |pr19−po9|, thus obtaining a second evaluation value C2.

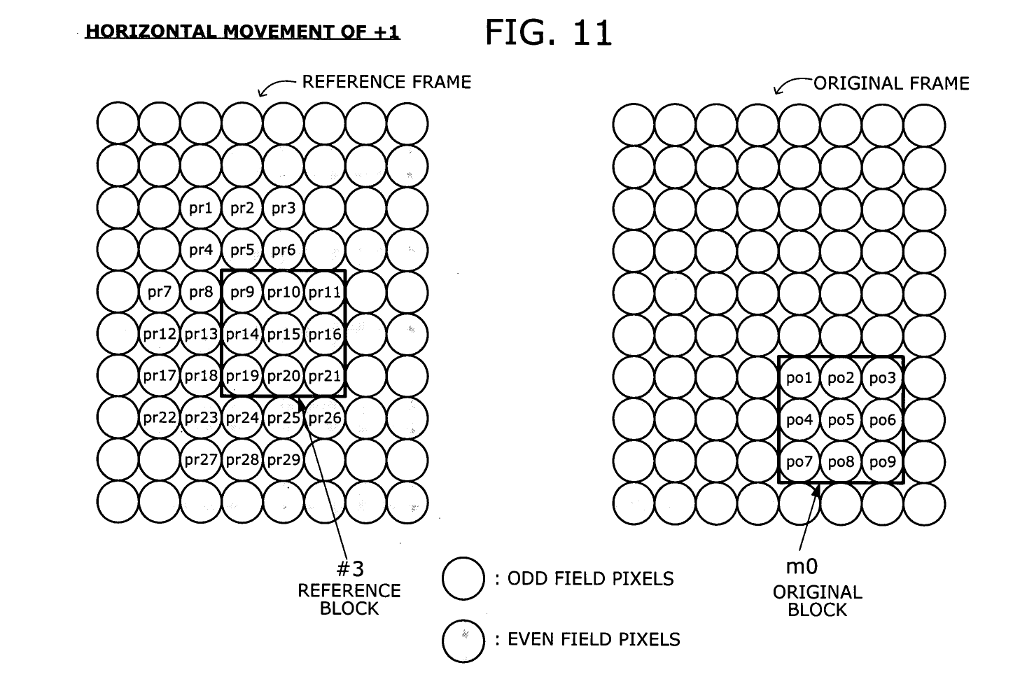

FIG. 11 shows a reference block #3 at the third search point #3, horizontally displaced by +1 pixel with respect to the search start point #1. This reference block #3 contains pixels pr9 to pr11, pr14 to pr16, and pr19 to pr21. The evaluation processor 12 sums up absolute pixel differences |pr9−po1|, |pr10−po2|, |pr11−po3|, |pr14−po4|, . . . |pr21−po9|, thus obtaining a third evaluation value C3.

FIG. 12 shows a reference block #4 at the fourth search point #4, vertically displaced by +2 pixels with respect to the search start point #1. This reference block #4 contains pixels pr18 to pr20, pr23 to pr25, and pr27 to pr29. The evaluation processor 12 sums up absolute pixel differences |pr18−po1|, |pr19−po2|, |pr20−po3|, |pr23−po4|, . . . |pr29−po9|, thus obtaining a fourth evaluation value C4.

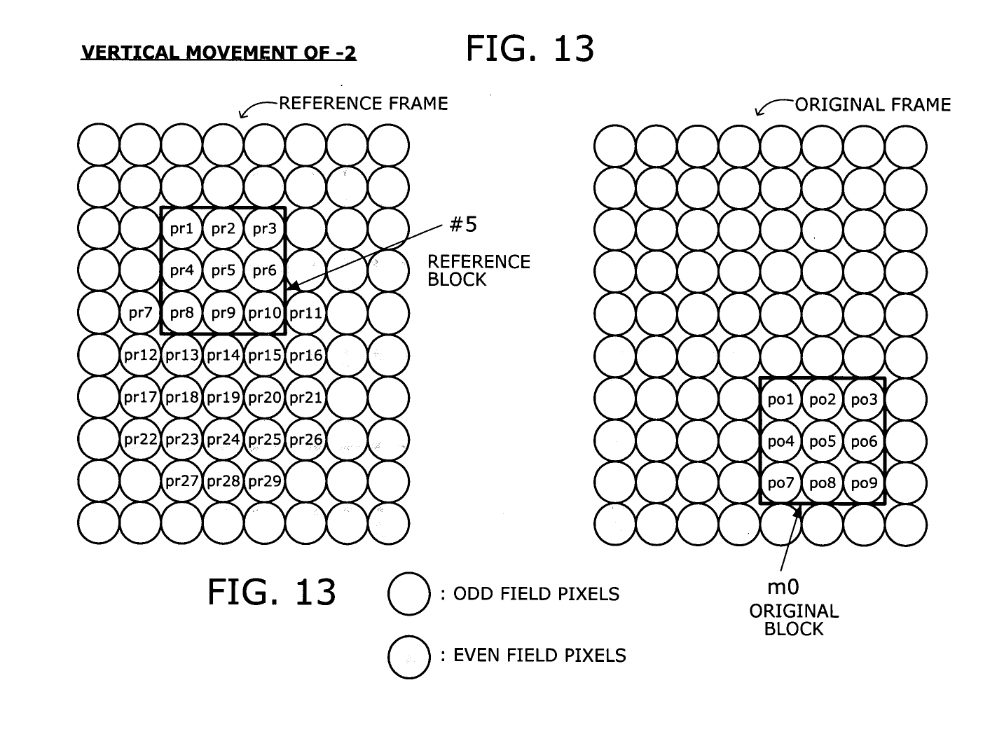

FIG. 13 shows a reference block #5 at the fifth search point #5, vertically displaced by −2 pixels with respect to the search start point #1. This reference block #5 contains pixels pr1 to pr3, pr4 to pr6, and pr8 to pr10. The evaluation processor 12 sums up absolute pixel differences |pr1−po1|, |pr2−po2|, |pr3−po3|, |pr4−po4|, . . . |pr10−po9|, thus obtaining still a fifth evaluation value C5.

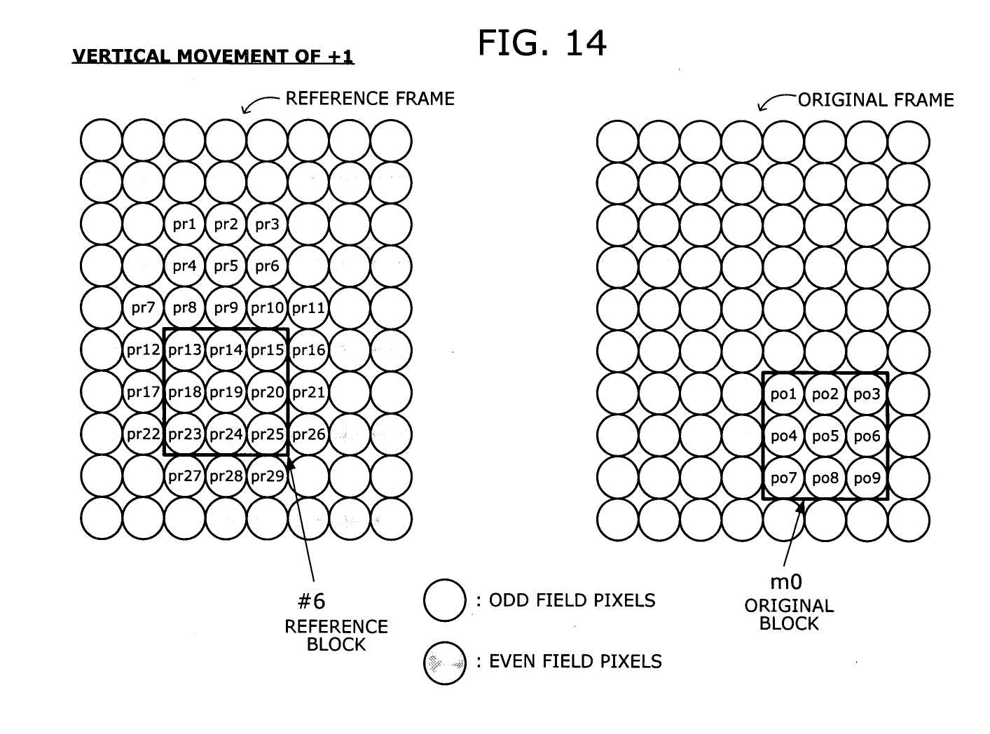

FIG. 14 shows a reference block #6 at the sixth search point #6, vertically displaced by +1 pixel with respect to the search start point #1. This reference block #6 contains pixels pr13 to pr15, pr18 to p20, and pr23 to pr25. The evaluation processor 12 sums up absolute pixel differences |pr13−po1|, |pr14−po2|, |pr15−po3|, |pr18−po4|, . . . |pr25−po9|, thus obtaining a sixth evaluation value C6.

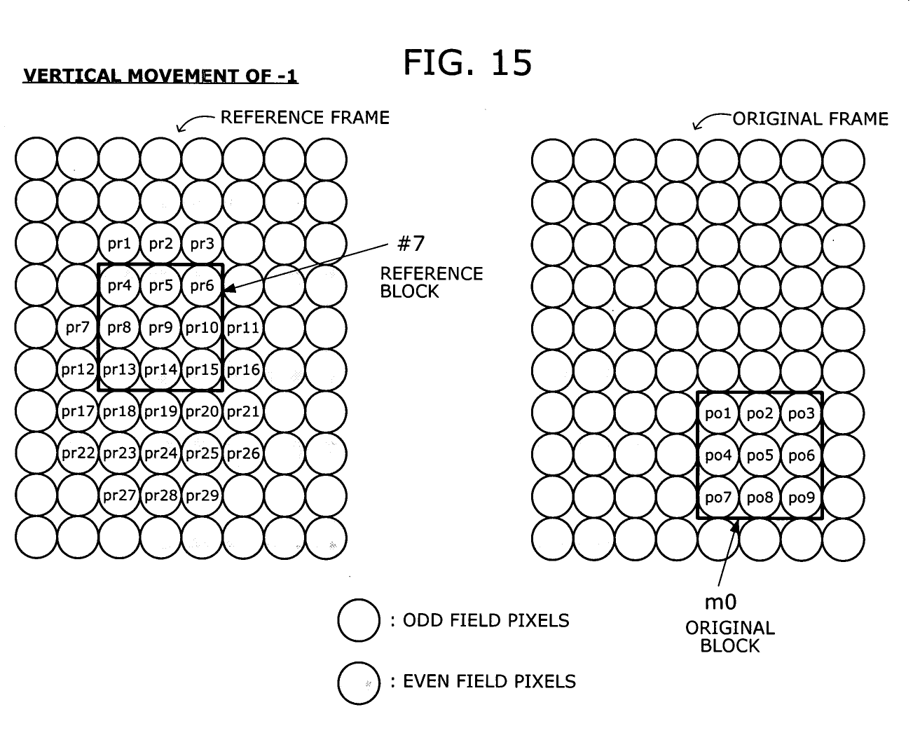

FIG. 15 shows a reference block #7 at the seventh search point #7, vertically displaced by −1 pixel with respect to the search start point #1. This reference block #7 contains pixels pr4 to pr6, pr8 to p10, pr13 to pr15. The evaluation processor 12 sums up absolute pixel differences |pr4−po1|, |pr5−po2|, |pr6−po3|, |pr8−po4|, . . . |pr15−po9|, thus obtaining a seventh evaluation value C7. Then the evaluation processor 12 selects the smallest evaluation value from among C1 to C7 and moves the focus to its corresponding reference block to continue the search.

As can be seen from the above, the pattern PT1 is similar to the conventional search pattern of basic DS as far as the horizontal movements are concerned. That is, the reference macroblock moves one pixel leftward and rightward as shown in FIGS. 10 and 11. As to the vertical directions, however, the pattern PT1 covers 2n lines (n=1, 2, . . . ) in both upward and downward directions as depicted in FIGS. 12 to 15, so that the original block m0 can be compared with reference pixels belonging to different fields.

Referring to FIG. 15, for example, the reference block is moved upward by one line, permitting the original block m0 to be compared with a reference block #7 in different field combinations (i.e., even line versus odd line). Referring to FIG. 13, the reference block is moved upward by two lines, permitting the original block m0 to be compared with a reference block #5 in the same field combinations (i.e., even line versus even line, or odd line versus odd line).

Referring to FIG. 14, the reference block is moved downward by one line, permitting the original block m0 to be compared with a reference block #6 in the same field combinations. Referring to FIG. 12, the reference block is moved downward by two lines, permitting the original block m0 to be compared with a reference block #4 in the same field combinations.

The basic DS and other conventional algorithms shift a reference block by only a single pixel in a vertical direction even in the case of interlaced frames. According to the present invention, the proposed motion vector estimation apparatus 10 gives a reference block a vertical movement of 2n lines across different field lines. Search movements of this type are referred to as “extended search movements.” While extended search movements generally cover 2n lines in either direction, the foregoing pattern PT1 is the case of n=1.

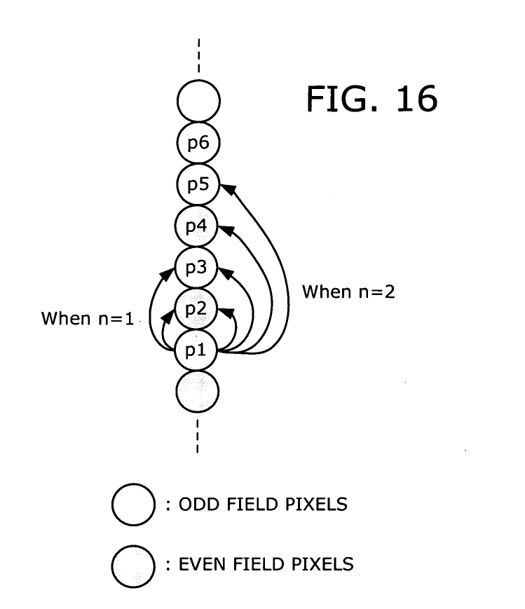

FIG. 16 depicts extended search movements in a simplified way, only showing vertical pixels. The hatched circles represent even-field pixels and the non-hatched circles represent odd-field pixels. Note that FIG. 16 omits downward movements since they are symmetrical with upward movements.

When n=1, the coverage of extended search movements is two pixels (two lines). Assuming that the search starts at pixel p1, the search pattern in n=1 moves the reference block to an even-field pixel p2 (one line above p1) and then to an odd-field pixel p3 (two lines above p1).

When n=2, the coverage of extended search movements is four pixels (four lines). The search pattern in n=2 moves the reference block to an even-field pixel p2 (one line above p1), an odd-field pixel p3 (two lines above p1), an even-field pixel p4 (three line above p1), and an odd-field pixel p5 (four lines above p1). Those skilled in the art will appreciate that the search coverage will be expanded in a similar way in the case of n=3 or above.

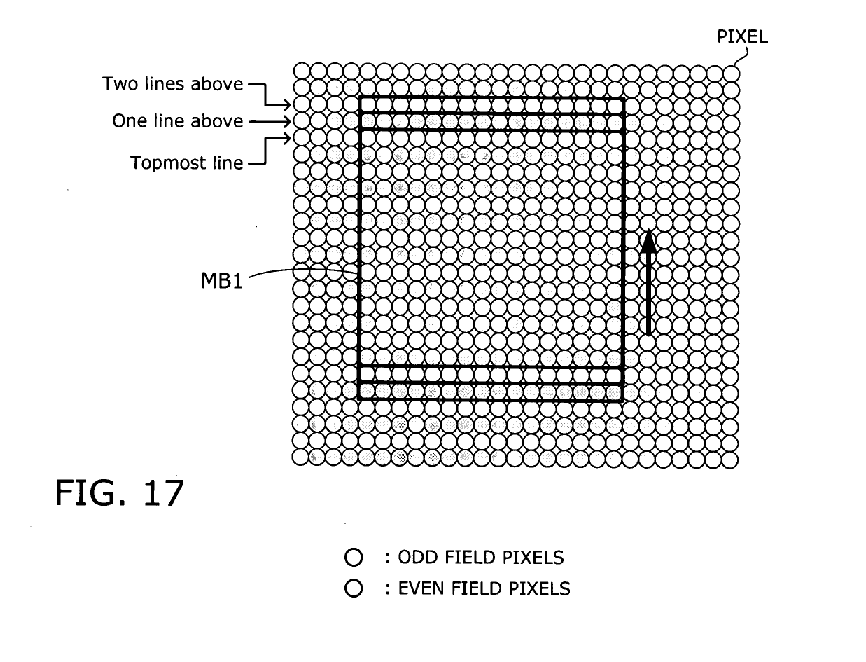

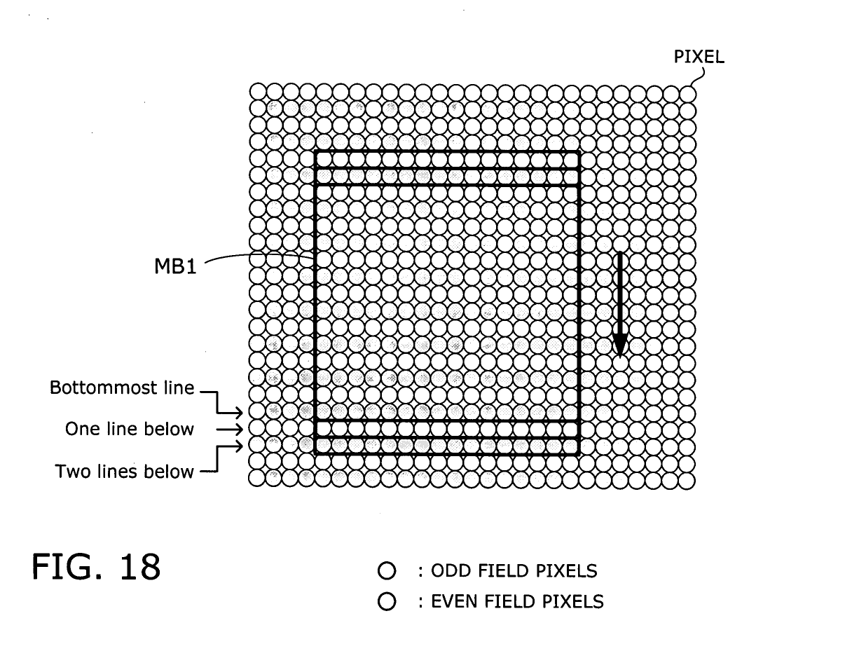

FIGS. 17 and 18 show macroblock movements in an extended search, assuming the case of n=1 (which is expected to be the most likely option). More specifically, FIG. 17 shows vertical movements of −1 and −2, and FIG. 18 shows vertical movements of +1 and +2.

Referring to FIG. 17, the topmost line of a reference macroblock MB1 currently lies on the odd field. In the case of n=1, the search pattern moves this reference macroblock MB1 upward across different field lines, to one line above the current topmost line, and then to two lines above the same, thus including a new pair of even and odd lines in the search coverage.

Referring to FIG. 18, the bottommost line of a reference macroblock MB1 currently lies on the even field. In the case of n=1, the search pattern moves this reference macroblock MB1 downward across different field lines, to one line below the current bottommost line, and then to two lines below the same, thus including a new pair of even and odd lines in the search coverage.

To generalize what is shown in FIGS. 17 and 18, the extended search movements may be upward or downward, and there will be actually four cases of extended search movements in n=1 when moving a reference macroblock upward or downward from its search start point. Specifically, the subsequent movements depend upon which field, even or odd, contains the topmost line or bottommost line of the reference macroblock sitting at a search start point. The cases are as follows:

(a) when the odd field contains the topmost line, subsequent upward movements carry the reference macroblock up to an even line immediately above the topmost line and also to an odd line two lines above the topmost line;

(b) when the even field contains the topmost line, subsequent upward movements carry the reference macroblock up to an odd line immediately above the topmost line and also to an even line two lines above the topmost line;

(c) when the odd field contains the bottommost line, subsequent downward movements carry the reference macroblock down to an even line immediately below the bottommost line and also to an odd line two lines below the bottommost line; and

(d) when the even field contains the bottommost line, subsequent downward movements carry the reference macroblock down to an odd line immediately below the bottommost line and also to an even line two lines below the bottommost line.

As can be seen from the above explanation, the motion vector estimation apparatus 10 uses extended search movements in vertical directions, thereby reducing the possibility of improper motion estimation discussed earlier in FIG. 6. The proposed algorithm works effectively for interlaced videos by adequately expanding the search domain with optimized search points and search patterns, such that the chances of erroneous estimation will be reasonably reduced. The computational load of motion vector calculation is not increased too much, and the algorithm can be implemented in a small circuit with low power consumption.

The above-described extended search movements may always be enabled when moving a reference macroblock in vertical directions. This implementation will certainly improve the accuracy of motion vector estimation, with far less computational load than in the case of a simply enlarged search domain.

To further reduce the burden of computation, the search pattern generator 13 may be designed to selectively enable extended search patterns for vertical movements of reference macroblocks in two particular cases. More specifically, one such case is the very beginning of a motion estimation process. That is, the search pattern generator 13 always produces extended search patterns when it begins searching with an initial search pattern like PT1.

The other case is when the preceding evaluation step finds a minimum point as a result of a vertical movement of a reference macroblock. Suppose, for example, that the process flow includes search patterns P0, P1, and P2 in that order, and that a minimum point in P1 is found as a result of a vertical search movement. In this case, the next pattern P2 will use an extended vertical search movements because of the following reason. The fact that a minimum point is found as a result of a vertical movement in the previous search pattern P1 means that the previous search pattern P1 might have used an extended search movement to reach that minimum point. This also suggests that the current frame has a large temporal change between fields, but a high correlation within a field.

The search pattern generator 13 takes advantage of an extended search pattern in the two cases described above, while restricting other vertical movements from being extended. This policy makes it possible to reduce the amount of computation, besides improving the accuracy of motion vector estimation.

### Search Patterns PT2

FIG. 19 shows example search patterns PT2, which come after the initial search pattern PT1 of FIG. 8. In addition to the same notation as in FIG. 8, FIG. 19 uses black circles and black triangles to indicate evaluated search points. PT2 is actually a collection of different search patterns, the details of which are as follows:

(a) Pattern PT2-0 is used when the preceding search pattern PT1 finds its search start point #1 to be a minimum. In this case the search start point stays as is.

Pattern PT2-0 includes ten new search points #2 to #11 (renumbered) distributed in oblique and horizontal directions around the search start point #1. The estimation process begins with a parallel evaluation of search points #2 and #3 performed by the units #0 and #1. The units #0 and #1 also work together to evaluate subsequent search points #4 and #5, #6 and #7, #8 and #9, and #10 and #11, two at a time.

(b) Pattern PT2-1a is used when the preceding search pattern PT1 finds its seventh search point #7 to be a minimum. While not shown in detail in FIG. 19, pattern PT2-1b is a vertically symmetric version of PT2-1a, which is used when the preceding search pattern PT1 finds its sixth search point #6 to be a minimum. Because of their symmetry, the following explanation will focus on PT2-1a.

Pattern PT2-1a includes its own search start point #1 and five other search points #2 to #6 (renumbered) distributed in oblique, upward, and horizontal directions around the search start point #1. The estimation process begins with evaluation of the search start point #1 performed by the unit #0 alone. The units #0 and #1 work together to evaluate subsequent search points #2 and #3, and then #4 and #5, two at a time. Lastly the unit #0 evaluates the sixth search point #6.

This pattern PT2-1a includes extended search movements of one and two lines in the upward direction since it is invoked by discovery of a minimum point as a result of an upward search movement in PT1. Note that the point immediately above the search start point #1 is skipped because that point has been evaluated as part of the previous pattern PT1. For this reason, the pattern PT2-1a actually produces only one extended search movement, i.e., up to the point #6 two lines above the search start point #1.

(c) Pattern PT2-2a is used when the preceding search pattern PT1 finds its fifth search point #5 to be a minimum. While not shown in detail in FIG. 19, pattern PT2-2b is a vertically symmetric version of PT2-2a, which is used when the preceding search pattern PT1 finds its fourth point #4 to be a minimum. Because of their symmetry, the following explanation will focus on PT2-2a.

Pattern PT2-2a includes its own search start point #1 and six other search points #2 to #7 (renumbered) distributed in horizontal, upward, and obliquely upward directions around the search start point #1. The estimation process begins with evaluation of the search start point #1 performed by the unit #0 alone. The units #0 and #1 then work together to evaluate subsequent search points #2 and #3, #4 and #5, and #6 and #7, two at a time.

This pattern PT2-2a includes extended search movements of one and two lines in the upward direction since it is invoked by discovery of a minimum point as a result of an upward search movement in PT1.

(d) Pattern PT2-3a is used when the preceding search pattern PT1 finds its third search point #3 to be a minimum. While not shown in detail in FIG. 19, pattern PT2-3b is a vertically symmetric version of PT2-3a, which is used when the preceding search pattern PT1 finds its second point #2 to be a minimum. Because of their symmetry, the following explanation will focus on PT2-3a.

Pattern PT2-3a includes its own search start point #1 and six other search points #2 to #7 (renumbered) arranged rightward, surrounding the search start point #1. The estimation begins with evaluation of the search start point #1 performed by the unit #0 alone. The units #0 and #1 then work together to evaluate subsequent search points #2 and #3, #4 and #5, and #6 and #7, two at a time.

### Post-PT2 Search Patterns

The preceding sections have fully described various search movements included in search patterns PT1 and PT2. This section briefly describes other search patterns that follow PT2.

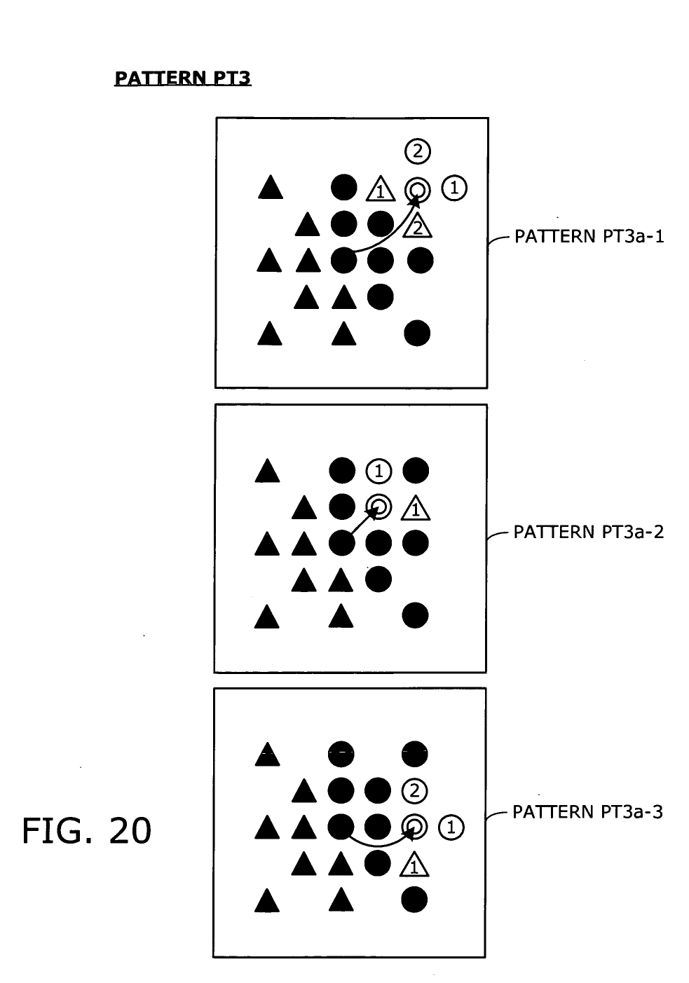

FIG. 20 shows a group of search patterns PT3, which come after PT2-0. They actually include three patterns: PT3a-1, PT3a-2, and PT3a-3. Pattern PT3a-1 is used when the preceding search pattern PT2-0 finds its fourth search point #4 to be minimum among all ten points. Although not shown or specifically described, there are some symmetrical variations of this pattern PT3a-1, which are: a horizontally symmetrical version used when point #5 is minimum, a vertically symmetrical version used when point #6 is minimum, and a horizontally and vertically symmetrical version used when point #7 is minimum.

Pattern PT3a-2 is used when the preceding search pattern PT2-0 finds its eighth search point #8 to be minimum among all ten points. Although not shown or specifically described, there are some symmetrical variations of this pattern PT3a-2, which are: a horizontally symmetrical version used when point #9 is minimum, a vertically symmetrical version used when point #10 is minimum, and a horizontally and vertically symmetrical version used when point #11 is minimum.

Pattern PT3a-3 is used when the preceding search pattern PT2-0 finds its second search point #2 to be minimum among all ten points. Although not shown or specifically described, there is a horizontally symmetrical variation of this pattern PT3a-3, which is used when point #3 is minimum.

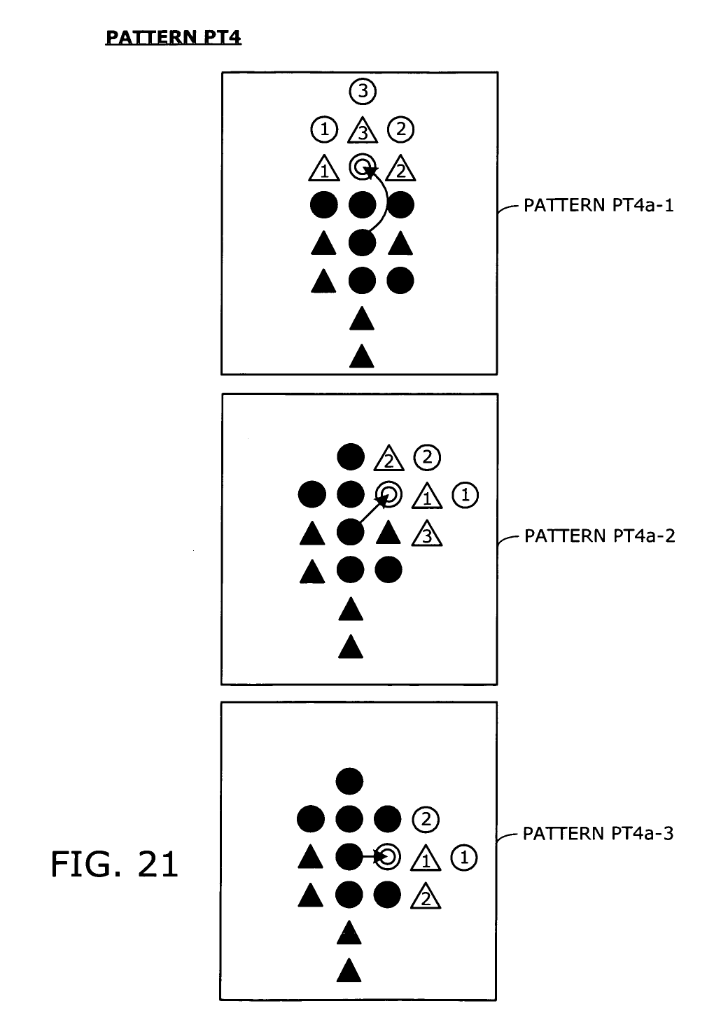

FIG. 21 shows a group of search patterns PT4, which come after PT2-1a of FIG. 19. They include three patterns PT4a-1, PT4a-2, and PT4a-3. Pattern PT4a-1 is used when the preceding search pattern PT2-1a finds its sixth search point #6 to be minimum among all six points. This pattern PT4a-1 includes extended search movements in the upward direction since it is invoked by discovery of a minimum point as a result of an upward search movement in PT2-1a.

Pattern PT4a-2 is used when the preceding search pattern PT2-1a finds its fourth search point #4 to be minimum among all six points. Although not shown or specifically described, there is a horizontally symmetrical variation of this pattern PT4a-2, which is used when point #2 is minimum.

Pattern PT4a-3 is used when the preceding search pattern PT2-1a finds its fifth search point #5 to be minimum among all six points. Although not shown or specifically described, there is a horizontally symmetrical variation of this pattern PT4a-3, which is used when point #3 is minimum.

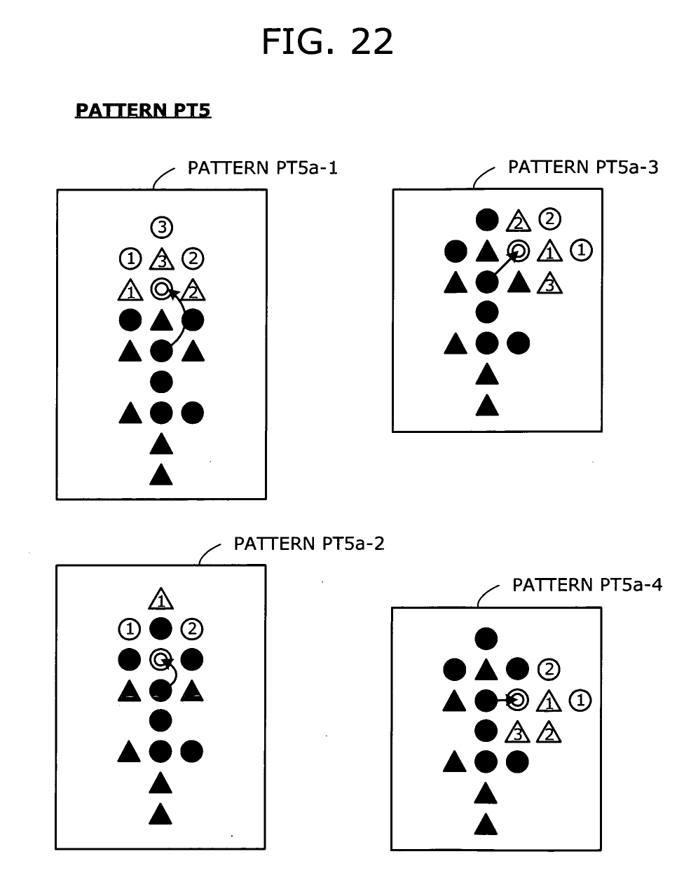

FIG. 22 shows a group of search patterns PT5, which come after PT2-2a of FIG. 19. PT5 includes the following four patterns: PT5a-1, PT5a-2, PT5a-3, and PT5a-4.

Pattern PT5a-1 is used when the preceding search pattern PT2-2a finds its sixth search point #6 to be minimum among all seven points. This pattern PT5a-1 includes extended search movements in the upward direction since it is invoked by discovery of a minimum point as a result of an upward search movement in PT2-2a.

Pattern PT5a-2 is used when the preceding search pattern PT2-2a finds its seventh search point #7 to be minimum among all seven points.

Pattern PT5a-3 is used when the preceding search pattern PT2-2a finds its fourth search point #4 to be minimum among all seven points. Although not shown or specifically described, there is a horizontally symmetrical variation of this pattern PT5a-3, which is used when point #2 is minimum.

Pattern PT5a-4 is used when the preceding search pattern PT2-2a finds its fifth search point #5 to be minimum among all seven points. Although not shown or specifically described, there is a horizontally symmetrical variation of this pattern PT5a-4, which is used when point #3 is minimum.

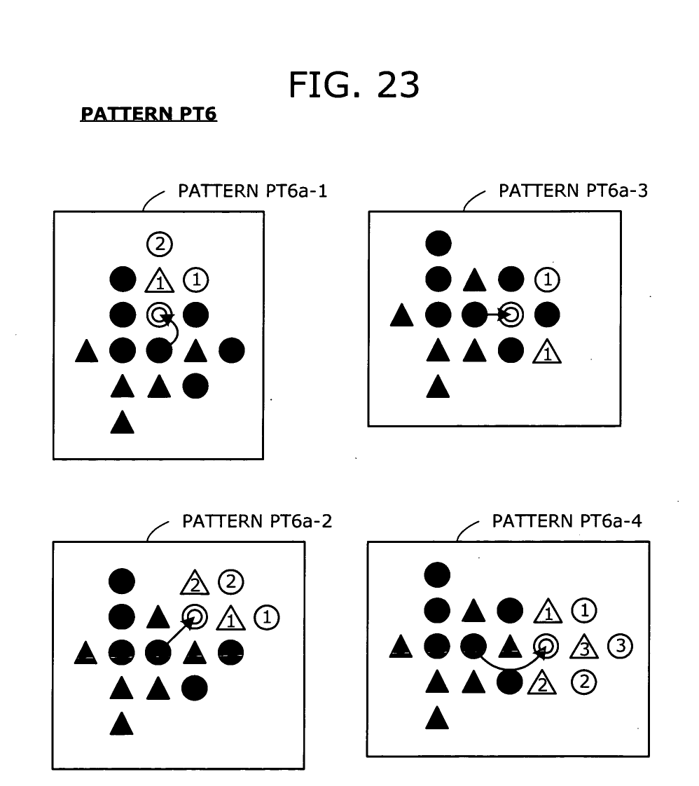

FIG. 23 shows a group of search patterns PT6, which come after PT2-3a of FIG. 19. PT6 includes the following four patterns: PT6a-1, PT6a-2, PT6a-3, and PT6a-4.

Pattern PT6a-1 is used when the preceding search pattern PT2-3a finds its fifth search point #5 to be minimum among all seven points. This pattern PT6a-1 includes extended search movements in the upward direction since it is invoked by discovery of a minimum point as a result of an upward search movement in PT2-3a. Although not shown or specifically described, there is a vertically symmetrical variation of this pattern PT6a-1, which is used when point #7 is minimum.

Pattern PT6a-2 is used when the preceding search pattern PT2-3a finds its fourth search point #4 to be minimum among all seven points. Although not shown or specifically described, there is a vertically symmetrical variation of this pattern PT6a-2, which is used when point #6 is minimum.

Pattern PT6a-3 is used when the preceding search pattern PT2-3a finds its third search point #3 to be minimum among all seven points.

Pattern PT6a-4 is used when the preceding search pattern PT2-3a finds its second search point #2 to be minimum among all seven points.

The search patterns shown in FIG. 8 and FIGS. 19 to 23 are designed to include extended search movements, vary the shape of themselves adaptively in accordance with where the search start point is heading, and keep the accumulated number of search points evaluated in the first three steps within a predetermined limit (e.g., 22 points in the present embodiment). The upper limit of search points is dependent on the processing performance. The pattern shapes shown in FIG. 8 and FIGS. 19 to 23 are illustrative only and may vary. The user is allowed to specify the shape and coverage of each search pattern as will be described in the next section.

### Search Pattern Table

FIG. 24 shows a search pattern table T1 owned by the search pattern generator 13. This user-configurable search pattern table T1 contains the following data items: “Last Point Flag,” “Search Movement Direction,” “Next Pattern Pointer,” and “Arithmetic Unit Assignment.” Those data items constitute a set of search movement parameters. Each table entry is stored in a memory address indicated beside the table in FIG. 24.

The last point flag field contains a flag indicating whether the search point is the last one within a corresponding search pattern. More specifically, a value of one represents the last point, and a value of zero represents start or intermediate points. The search movement direction field indicates where the search is heading for. More specifically, this field shows horizontal and vertical displacements of search points relative to the start point. The next pattern pointer field contains a memory address indicating where the next search pattern entry begins. The arithmetic unit assignment field specifies which of the arithmetic units #0 and #1 will be used to evaluate a search point.

The example table of FIG. 24 describes the search pattern PT1 of FIG. 8. Specifically, the search movement direction field contains seven pairs of horizontal (H) and vertical (V) displacements: (0, 0), (−1, 0), (+1, 0), (0, −1), (0, +1), (0, −2), and (0, +2). These pairs correspond to search points #1 to #7 of pattern PT1, to which the arithmetic units #0 and #1 are alternately assigned. The pattern PT1 ends with the seventh search point #7 at address 0×06, and its corresponding last point flag is therefore set to one.

Referring to the topmost entry at address 0×00, its next pattern pointer field contains a value of 0×07. This means that, if the search point #1 is found minimum, the next step will take another pattern PT2-0 beginning at address 0×07. The table entries at 0×07 and so on define specific search points of the next pattern PT2-0, although not shown in FIG. 24.

Referring to the second to the bottom entry, its next pattern pointer field contains a value of 0×**, indicating which table entry should be used in the case the seventh search point #7 is found minimum. Although not shown in FIG. 24, the next pattern in this case is PT2-1a, whose search points are defined in the table entries at address 0×** and so on.

While FIG. 24 shows no next pattern pointers for other table entries at addresses 0×01 to 0×05, they actually have specific pointer values indicating their respective next search patterns.

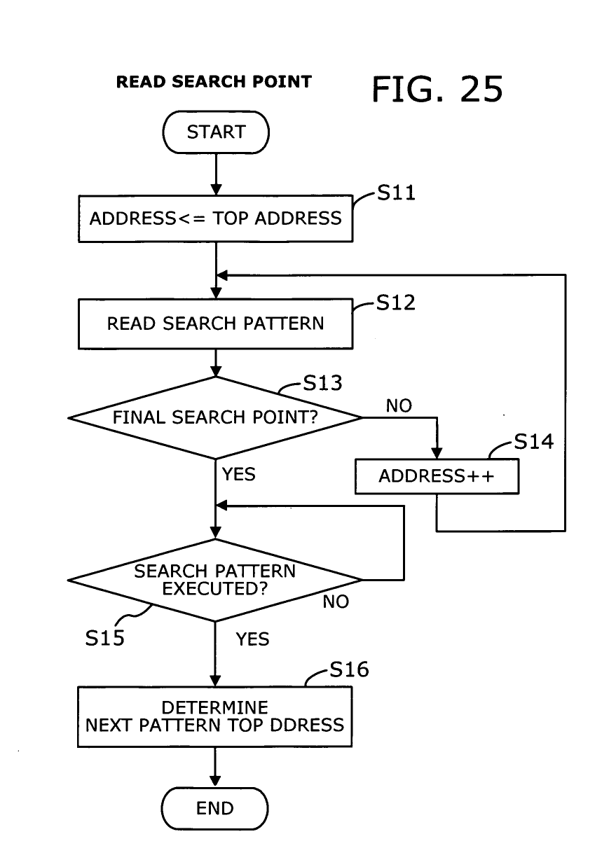

FIG. 25 is a flowchart showing how a search pattern is read out of the search pattern table T1. Specifically, the read process proceeds as follows:

(S11) The table pointer is set to the top address of a search pattern.

(S12) A table entry (search movement parameters) is read out of the address specified by the table pointer.

(S13) If the last search point is reached (i.e., if the last point flag is set), the process advances to step S15. Otherwise, the process proceeds to step S14.

(S14) The process goes back to step S12 after incrementing the address pointer.

(S15) The process waits for the completion of the current search pattern.

(S16) The process determines the next search pattern and fetches its top address.

### First Variation

As a first variation of the present embodiment, the proposed motion vector estimation apparatus 10 may be configured to change the directions of motion prediction depending on picture types of original frames. Picture types will also affect the usage of arithmetic units #0 121 and #1 122 and selection of extended search and basic DS algorithms. The first variation can be implemented with the same device architecture as in FIG. 7.

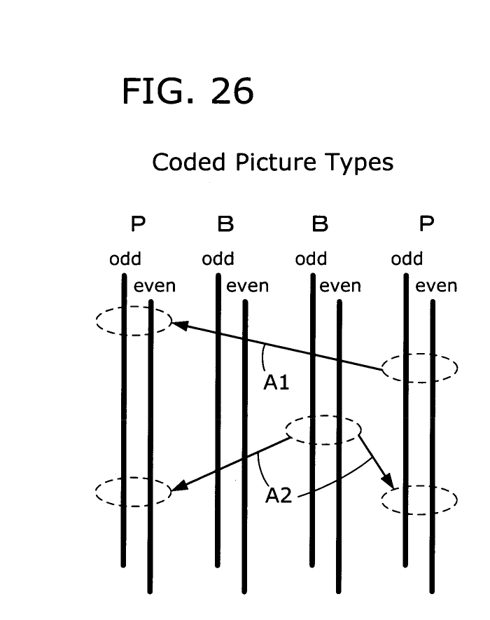

FIG. 26 shows prediction directions determined depending on picture types. When the given original frame is supposed to be encoded into an interframe forward predictive coded picture (“predictive picture” or “P picture”), both the arithmetic unit #0 121 and arithmetic unit #1 122 work together to compare the original frame with a forward reference frame (another P picture) temporally preceding the original frame, as indicated by the arrow A1 in FIG. 26.

When the given original frame is supposed to be encoded into a bidirectionally predictive coded picture (“B picture”), one arithmetic unit #0 121 compares the original picture with a forward reference frame (P picture) temporally preceding the original frame, and concurrently, the other arithmetic unit #1 122 compares the original picture with a backward reference frame (another P picture) temporally succeeding the original frame, as indicated by the arrows A2 in FIG. 26.

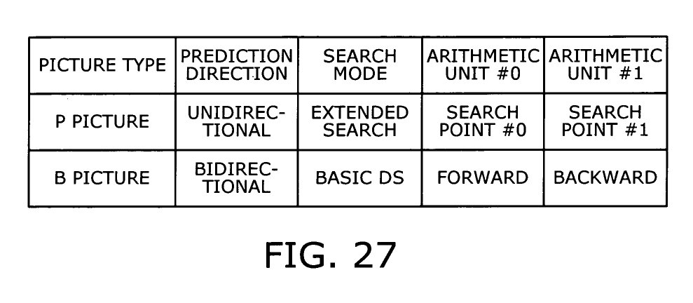

FIG. 27 summarizes the search mode and arithmetic unit assignment corresponding to each picture type of original frames. In the case of coding a given original frame into a P picture, its preceding P picture is searched as a reference frame in extended search mode (i.e., the reference macroblock is vertically moved to extended search points). Both the arithmetic unit #0 121 and arithmetic unit #1 122 are used to evaluate pixel differences between the original frame and forward reference frame.

In the case of coding a given original picture into a B picture, its preceding P picture and succeeding P picture are searched as a forward reference frame and a backward reference frame, respectively, in basic DS mode (i.e., no extended search movements are used in moving the reference macroblock vertically). One arithmetic unit #0 121 is assigned for evaluation of the forward reference frame (P picture), while the other arithmetic unit #1 122 is assigned for evaluation of the backward reference frame (P picture).

The MPEG coding involves motion prediction in one or two directions depending on pictures. P pictures are unidirectionally predicted while B pictures are bidirectionally predicted. B pictures thus require two times as much computation as P pictures do, although both types of pictures have the same number of search points that must be evaluated. To process such load-intensive B pictures, the motion vector estimation apparatus chooses a basic DS algorithm (rather than extended search algorithm) to alleviate the burden, as well as distributing evaluation tasks to two arithmetic units #0 and #1. Extended search is only activated when coding original frames into light-loading P pictures, using both arithmetic units #0 and #1 for calculation. This adaptive switching of search mode and arithmetic unit assignment according to picture types makes it possible to estimate motion vectors more accurately, with reasonably expanded search domains, and without increasing computational load too much.

### Second Variation

As a second variation of the present embodiment, the motion vector estimation apparatus 10 may be designed to enable extended search for vertical search movements only for original macroblocks located in a central part of the frame.

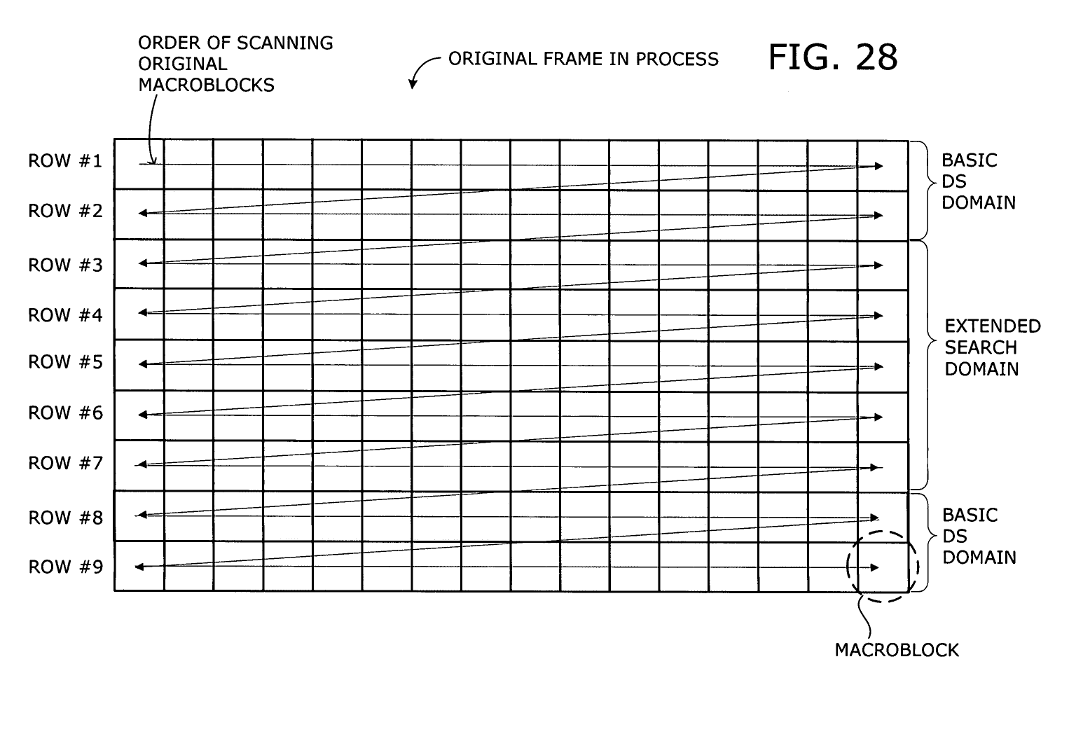

FIG. 28 shows the second variation of the present embodiment, where a simplified frame consists of 9 rows of 16 macroblocks. The topmost two rows #1 and #2 and the bottommost two rows #8 and #9 are search with a basic DS algorithm, while the remaining five rows #3 to #7 are searched with an extended search algorithm.

The search pattern generator 13 does not perform extended search movements for vertical directions if the currently focused original macroblock is located in the topmost n rows or bottommost m rows of the original frame. Extended search patterns are used only when the currently focused original macroblock lies in the (n+1)th to (m−1)th rows of the original frame.

People tend to watch the central part of a screen, with less attention to outer regions. According to the second variation, extended search patterns are used only for the central part, whereas the basic DS algorithm serves other part. This mechanism makes it possible to estimate motion vectors more accurately, with reasonably expanded search domains, and without increasing computational load too much.

### Third Variation

As a third variation of the present embodiment, the motion vector estimation apparatus 10 may be designed to enable an extended search for vertical search movements of a reference macroblock only when a large variation is observed in motion vectors of some macroblocks surrounding the currently focused original macroblock.

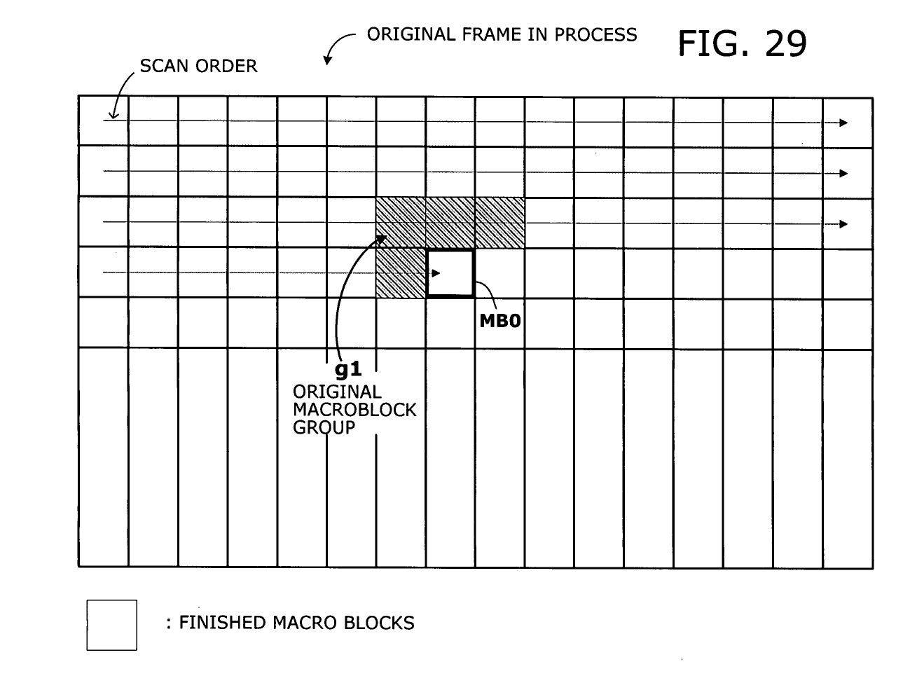

FIG. 29 shows the third variation of the present embodiment. MB0 is an original macroblock that is currently in process of motion estimation, and g1 represents a group of finished macroblocks surrounding the original macroblock MB0 in the same frame. The original macroblocks in the group g1 have their respective motion vectors. If those motion vectors have a relatively large variation, then the motion vector estimation apparatus of the third variation expects that the currently focused original macroblock MB0 would also have a large motion vector, and it thus uses an extended search in comparing the original macroblock MB0 with reference macroblocks.

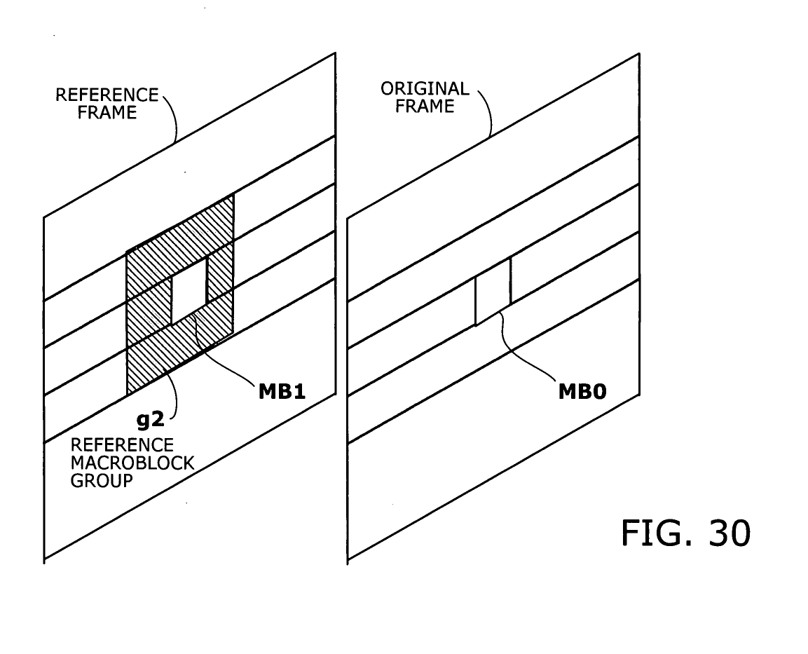

FIG. 30 also shows the third variation of the present embodiment. Think of a reference macroblock MB1 located at the same position as an original macroblock MB0. Suppose that the evaluation processor 12 has evaluated macroblocks surrounding the reference macroblock MB1. Those evaluated reference macroblocks form a reference macroblock group g2. Some or all reference macroblocks in the group g2 may be correlated well with some original macroblocks, thus having respective motion vectors. If those motion vectors have a relatively large variation, then the motion vector estimation apparatus of the third variation expects that the reference macroblock MB1 would result in a large motion vector, and it thus uses extended search movements in comparing the original macroblock MB0 with the reference macroblock MB1.

As can be seen from FIGS. 29 and 30, the extended search is selectively used in a more appropriate part of a frame. This tactics contributes to an improved efficiency of motion estimation computation.

### Advantages

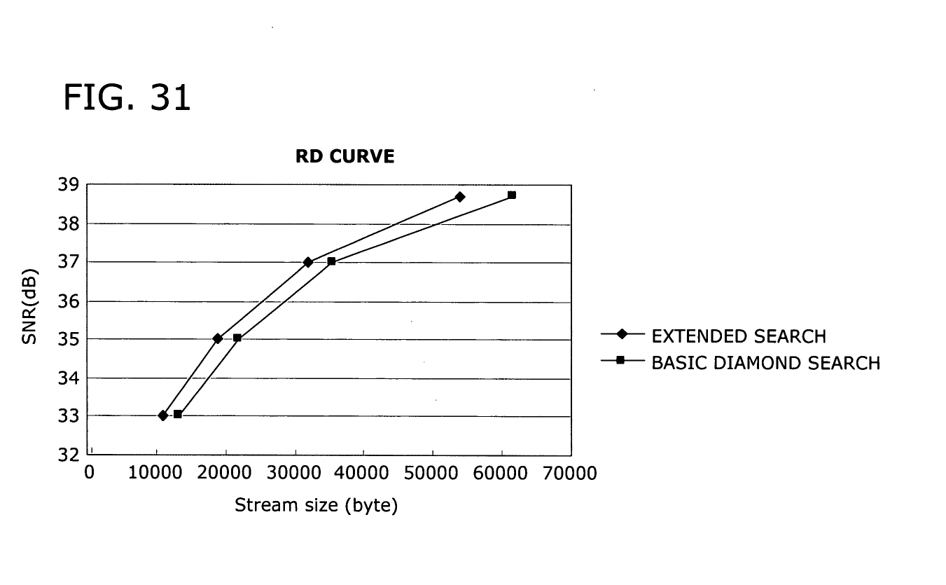

FIG. 31 demonstrates an advantage of the motion vector estimation apparatus according to the present embodiment, where the vertical axis represents signal-to-noise ratio (SNR) in decibels (dB) and the horizontal axis represents stream size in bytes. Shown in FIG. 31 are rate distortion (RD) curves indicating S/N ratios obtained at different coding rates. Generally a higher coding rate results in a higher S/N ratio since more video information can be produced. The RD curves of FIG. 31 show how much improvement of S/N ratios can be achieved by the extended search at each coding rate. As can be seen, the extended search algorithm beats the basic DS algorithm throughout the range of coding rate, with a maximum gain of about 0.5 dB.

### Conclusion

To summarize the above discussion, the present invention provides a motion vector estimation apparatus starts each evaluation step at a search start point identified in a previous evaluation step as being a minimum. When moving a reference macroblock in vertical directions, the apparatus uses extended search movements of 2n lines (n=1,2, . . . ), so that the reference macroblock will move across different field lines. This extended search algorithm expands the search coverage in vertical directions, thus enabling macroblocks to be compared not only in the same field combinations, but also in different field combinations. With reasonably expanded search domains, the present invention makes it possible to estimate motion vectors more accurately, without increasing computational load too much.

The foregoing embodiment of the invention and its variations have assumed a macroblock dimension of 16 pixels by 16 pixels specified in H.264 and other standards. However, as can be seen from the technical details described above, the present invention is not limited to any particular shape or dimension of blocks. Rather, the extended search movement and motion vector estimation of the present invention can be implemented with any desired dimension of blocks, such as N×M pixels. Also the expanded search algorithm may be used, not only for vertical search movements, but also for other directions such as obliquely upward or obliquely downward.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A motion vector estimation apparatus that estimates motion vectors from interlaced video frames each composed of odd and even fields, the apparatus comprising:
a reference macroblock mover that moves a reference macroblock in a given reference frame according to search movement parameters contained in a given search pattern of a current evaluation step, starting from a search start point that is identified as a minimum point in a preceding evaluation step;
an evaluation processor that calculates an evaluation value being either a sum of absolute differences or a square sum of differences between corresponding pixels of the reference macroblock and an original macroblock in a given original frame, with a plurality of search movements performed by the reference macroblock mover, thus extracting a minimum evaluation value among as many evaluation values as the number of search movements performed in one evaluation step and finding an absolute minimum point from the extracted minimum evaluation values;
a search pattern generator that provides the reference macroblock mover with search patterns each giving a set of search movement parameters for one evaluation step, search movement parameters including extended search parameters that specify extended search movements of 2n lines (n=1, 2, . . . ) in a vertical direction so as to move the reference macroblock across different field lines; and
a motion vector estimator that identifies the reference macroblock at the absolute minimum point as being most correlated with the original macroblock, and calculates a motion vector representing a distance and direction of the original macroblock relative to the identified reference macroblock.

2. The motion vector estimation apparatus according to claim 1, wherein the extended search movements in n=1 include upward and downward movements dependent upon which field contains the topmost line or bottommost line of the reference macroblock sitting at a search start point, and wherein:
(a) when the odd field contains the topmost line, the upward movements carry the reference macroblock up to an even line immediately above the topmost line and also to an odd line two lines above the topmost line;
(b) when the even field contains the topmost line, the upward movements carry the reference macroblock up to an odd line immediately above the topmost line and also to an even line two lines above the topmost line;
(c) when the odd field contains the bottommost line, the downward movements carry the reference macroblock down to an even line immediately below the bottommost line and also to an odd line two lines below the bottommost line; and
(d) when the even field contains the bottommost line, the downward movements carry the reference macroblock down to an odd line immediately below the bottommost line and also to an even line two lines below the bottommost line.

3. The motion vector estimation apparatus according to claim 1, wherein:
the evaluation processor comprises a plurality of arithmetic units for calculating the evaluation values in a parallel fashion; and
the search movement parameters include instructions specifying how to distribute tasks of each evaluation step to the arithmetic units.

4. The motion vector estimation apparatus according to claim 3, wherein:
the plurality of arithmetic units include first and second arithmetic units; and
both the first and second arithmetic units work together to compare the original frame with a forward reference frame temporally preceding the original frame, when the original frame is supposed to be encoded into an interframe forward predictive coded frame; and
the first arithmetic unit compares the original frame with a forward reference frame temporally preceding the original frame, while the second arithmetic unit compares the original frame with a backward reference frame temporally succeeding the original frame, when the original frame is supposed to be encoded into a bidirectionally predictive coded frame.

5. The motion vector estimation apparatus according to claim 4, wherein:
the reference macroblock mover performs the extended search movements of the reference macroblock when the original frame is supposed to be encoded into an interframe forward predictive coded frame; and
the reference macroblock mover performs no extended search movements of the reference macroblock when the original frame is supposed to be encoded into a bidirectionally predictive coded frame.

6. The motion vector estimation apparatus according to claim 1, wherein the reference macroblock mover performs the extended search movements of the reference macroblock for vertical search movements in the current evaluation step when the minimum point is found in the preceding evaluation step as a result of a vertical search movement of the reference macroblock.

7. The motion vector estimation apparatus according to claim 1, wherein the search pattern generator receives definitions of the search patterns from an external source.

8. The motion vector estimation apparatus according to claim 1, wherein the extended search parameters in the search pattern generator specify that the extended search movements be used only when the original macroblock in process is located in a central portion of the original frame.

9. The motion vector estimation apparatus according to claim 1, wherein the extended search parameters in the search pattern generator specify that the extended search movements be used only to evaluate the original macroblock whose surrounding macroblocks have motion vectors with a large variation.

10. A method of estimating motion vectors from interlaced video frames each composed of odd and even fields, the method comprising:
providing search patterns each giving a set of search movement parameters used for one evaluation step, the search movement parameters each specifying a movement of a reference macroblock in a given reference frame, the search movement parameters including extended search parameters that specify extended search movements of 2n lines (n=1, 2, . . . ) in a vertical direction so as to move the reference macroblock across different field lines;
moving the reference macroblock according to the search movement parameters contained in the search pattern of a current evaluation step, starting from a search start point that is identified as a minimum point in a preceding evaluation step;
calculating an evaluation value being either a sum of absolute differences or a square sum of differences between corresponding pixels of the reference macroblock and an original macroblock in a given original frame, with a plurality of search movements performed by said moving of the reference macroblock;
extracting a minimum evaluation value among as many evaluation values as the number of search movements performed in each evaluation step;
finding an absolute minimum point from the extracted minimum evaluation values; and
identifying the reference macroblock at the absolute minimum point as being most correlated with the original macroblock, and calculating a motion vector representing a distance and direction the original macroblock relative to the identified reference macroblock.
